(19) United States
(12) Patent Application Publication
(10) Pub. No.: US 2019/0288331 A1
(43) Pub. Date: Sep. 19, 2019

(54) SOLID-STATE ELECTROLYTES WITH BIOMIMETIC IONIC CHANNELS FOR BATTERIES AND METHODS OF MAKING SAME

(71) Applicant: Ford Cheer International Limited, Road Town (VG)

(72) Inventors: Jianguo Xu, Walnut, CA (US); Yunfeng Lu, Culver City, CA (US); Li Shen, Los Angeles, CA (US)

(21) Appl. No.: 16/369,031

(22) Filed: Mar. 29, 2019

Related U.S. Application Data
(63) Continuation-in-part of application No. 15/888,232, filed on Feb. 5, 2018.
Application No. 15/888,232 is a continuation-in-part of application No. 15/888,223, filed on Feb. 5, 2018.
(60) Provisional application No. 62/650,580, filed on Mar. 30, 2018.
(60) Provisional application No. 62/650,623, filed on Mar. 30, 2018.
(60) Provisional application No. 62/455,752, filed on Feb. 7, 2017.
(60) Provisional application No. 62/455,800, filed on Feb. 7, 2017.
(60) Provisional application No. 62/455,752, filed on Feb. 7, 2017.
(60) Provisional application No. 62/455,800, filed on Feb. 7, 2017.

(51) Int. Cl. H01M 10/0562; H01M 10/0525

(52) U.S. Cl. CPC H01M 10/0562; H01M 2300/0071; H01M 10/0525

(57) ABSTRACT

One aspect of the invention relates to a novel class of solid-state electrolytes with biomimetic ionic channels as ionic conductors for electrochemical devices, e.g., batteries. This is achieved by complexing the anions of an electrolyte to the open metal sites of metal-organic frameworks (MOFs), which renders the MOF scaffolds into ionic-channel analogs with fast lithium-ion conductivity and low activation energy.

### CROSS-REFERENCE TO RELATED PATENT APPLICATIONS

This application claims priority to and the benefit of U.S. Provisional Patent Application Ser. Nos. 62/650,580, and 62/650,623, both filed Mar. 30, 2018.

This application also is a continuation-in-part application of U.S. patent application Ser. No. 15/888,232, filed Feb. 5, 2018, which itself claims priority to and the benefit of U.S. Provisional Patent Application Ser. Nos. 62/455,752 and 62/455,800, both filed Feb. 7, 2017.

This application also is a continuation-in-part application of U.S. patent application Ser. No. 15/888,223, filed Feb. 5, 2018, which itself claims priority to and the benefit of U.S. Provisional Patent Application Ser. Nos. 62/455,752 and 62/455,800, both filed Feb. 7, 2017.

Each of the above-identified applications is incorporated herein by reference in its entirety.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference. In terms of notation, hereinafter, “[n]” represents the nth reference cited in the reference list. For example, [8] represents the 8th reference cited in the reference list, namely, Lu Y, Tu Z, Archer L A. Stable lithium electrodeposition in liquid and nanoporous solid electrolytes. Nat Mater 2014, 13(10): 961-969.

### FIELD

This present invention relates generally to batteries, and more particularly to solid electrolytes with biomimetic ionic channels and composite electrolyte membranes for batteries and methods of making the same.

### BACKGROUND

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present invention.

A growing demand exists for lithium-based batteries with increased energy density. As a “hostless” anode, lithium (Li) metal offers the highest capacity (3860 mA h g⁻¹) among anode materials for lithium-based batteries [1]. Adapting Li-metal anodes may substantially improve energy density, but has been hampered by its reactions with liquid electrolytes and instability of the resulted solid electrolyte interphase (SEI) layers [2]. Even though various strategies have been explored to stabilize Li-metal anodes, such as coating Li-metal anodes with polymers [3], ceramics [4-6] or carbons [7], and using halogenated salts or alkaline-metal salts as electrolyte additives [8, 9], the challenges remain unsolved. Developing solid electrolytes, in this context, is considered as a complete solution.

To date, most solid electrolytes can be categorized as either ceramic or polymeric electrolytes. Ceramic electrolytes generally exhibit ionic conductivity below 10⁻⁴ S cm⁻¹, which may be improved by tuning their phase structure and composition [10]. However, their implementation has encountered critical challenges, such as unsatisfactory electrochemical stability, sensitivity to moisture and oxygen, poor interfacial contact with electrodes, and high grain boundary resistance [11-15]. Despite recent advances in reducing interfacial resistance (e.g., by depositing aluminum oxide on solid electrolytes using an atomic layer deposition technique) [16], scalable adaptation of ceramic electrolytes remains challenging. Polymeric electrolytes usually exhibit ionic conductivity on the order of 10⁻⁵ S cm⁻¹ at room temperature. Although enhanced ionic conductivity (up to 10⁻³ S cm⁻¹) may be achieved by doping the electrolytes with extra liquid electrolyte or inorganic additives [17], the doping process generally decreases mechanical strength and the ability of the electrolytes to block dendrite growth.

Therefore, a heretofore unaddressed need exists in the art to address the aforementioned deficiencies and inadequacies.

### SUMMARY

One of the objectives is to provide a novel class of solid-state electrolytes with biomimetic ionic channels as ionic conductors for electrochemical devices, e.g., batteries. In certain embodiments, this is achieved by complexing the anions of an electrolyte to the open metal sites (OMSs) of metal-organic frameworks (MOFs), which renders the MOF scaffolds into ionic-channel analogs with fast lithium-ion conductivity and low activation energy.

In one aspect of the invention, the solid-state electrolyte includes a composite synthesized from an MOF material soaked in a liquid electrolyte, the MOFs being a class of crystalline porous solids constructed from metal cluster nodes and organic linkers.

In one embodiment, prior to soaking it into the a liquid electrolyte, the MOF material is activated under vacuum at a temperature greater than 150° C. for a period of time, e.g., overnight, so that the activated MOF material comprises OMSs that are corresponding to unsaturated metal centers created by activating pristine MOFs to remove guest molecules or partial ligands thereof.

In one embodiment, the MOF material comprises HKUST-1 having a formula of Cu₃(BTC)₂, MIL-100-Al having a formula of Al₃O(OH)(BTC)₂, MIL-100-Cr having a formula of Cr₃O(OH)(BTC)₂, MIL-100-Fe having a formula of Fe₃O(OH)(BTC)₂, UiO-66 having a formula of Zr₆O₄(OH)₄(BDC)₆, or UiO-67 having a formula of Zr₆O₄(OH)₄(BPDC)₆, wherein BTC is a benzene-1,3,5-tricarboxylic acid, BDC is a benzene-1,4-dicarboxylic acid, and BPDC is a biphenyl-4,4′-dicarboxylic acid.

In one embodiment, the liquid electrolyte comprises one or more non-aqueous solvents and metal salts dissolved in the one or more non-aqueous solvents. The one or more non-aqueous solvents are selected to match the surface properties of the MOF material. The metal salts are selected to have anions with desired sizes, which depends, at least in part, upon the MOF material, wherein the anion sizes are selected to ensure that the salts to infiltrate into at least some of the pores of the MOFs, and become immobilized therein to form the ionic conducting channels.

In one embodiment, the non-aqueous liquid electrolyte solvents comprise ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, cyclic ether compounds including at least one of tetrahydrofuran, 2-methyltetrahydrofuran, 1,3-dioxolane and dioxane, or a combination thereof.

In one embodiment, the metal salts comprise one or more of a lithium (Li) salt, a sodium (Na) salt, a magnesium (Mg) salt, and a zinc (Zn) salt,

In one embodiment, the liquid electrolyte comprises LiClO₄ and propylene carbonate, denoted as LPC.

In another aspect of the invention, the method for fabricating a solid-state electrolyte usable for ionic conductor for an electrochemical device includes: providing an MOF material, the MOFs being a class of crystalline porous solids constructed from metal cluster nodes and organic linkers; activating the MOF material under vacuum at a temperature greater than 150° C. for a period of time; soaking the activated MOF material in a liquid electrolyte to form a mixture; and filtrating the mixture and removing any excessive solvent to obtain the solid-state electrolyte in a free-flowing power form. In one embodiment, the period of time is more than 12 h.

In one embodiment, the method of further comprises pressing the power into pellets.

In one embodiment, the activated MOF material comprises OMSs that are corresponding to unsaturated metal centers created by activating pristine MOFs to remove guest molecules or partial ligands thereof.

In one embodiment, the MOF material comprises HKUST-1 having a formula of Cu₃(BTC)₂, MIL-100-Al having a formula of Al₃O(OH)(BTC)₂, MIL-100-Cr having a formula of Cr₃O(OH)(BTC)₂, MIL-100-Fe having a formula of Fe₃O(OH)(BTC)₂, UiO-66 having a formula of Zr₆O₄(OH)₄(BDC)₆, or UiO-67 having a formula of Zr₆O₄(OH)₄(BPDC)₆, wherein BTC is a benzene-1,3,5-tricarboxylic acid, BDC is a benzene-1,4-dicarboxylic acid, and BPDC is a biphenyl-4,4′-dicarboxylic acid.

In one embodiment, the liquid electrolyte comprises one or more non-aqueous solvents and metal salts dissolved in the one or more non-aqueous solvents, wherein the one or more non-aqueous solvents are selected to match the surface properties of the MOF material; and the metal salts are selected to have anions with desired sizes, which depends, at least in part, upon the MOF material, wherein the anion sizes are selected to ensure that the salts to infiltrate into at least some of the pores of the MOFs, and become immobilized therein to form the ionic conducting channels.

In one embodiment, the liquid electrolyte comprises LPC.

In yet another aspect of the invention, a composite electrolyte membrane usable for ionic conductor for an electrochemical device includes the solid-state electrolyte as disclosed above; and a binder mixed with the solid-state electrolyte.

In one embodiment, a concentration of the binder is in a range of 5-20 wt. % of the composite electrolyte membrane.

In one embodiment, the binder comprises poly-propylene (PP), poly-ethylene (PE), glass fiber (GF), polyethylene oxide (PEO), polyvinylidene fluoride (PVDF), polytetrafluoroethylene (PTFE), polyallylamine (PAH), polyurethane, polyacrylonitrile (PAN), polymethylmethacrylate (PMMA), polytetraethylene glycol diacrylate, or copolymers thereof.

In a further aspect of the invention, an electrochemical device has the composite electrolyte membrane as disclosed above; a positive electrode; and a negative electrode, wherein the composite electrolyte membrane is disposed between the positive electrode and the negative electrode.

In one embodiment, the electrochemical device is a lithium (Li) battery, a sodium (Na) battery, a magnesium (Mg) battery, or a zinc (Zn) battery.

In one embodiment, the positive electrode of the Li battery includes at least one of LiCoO₂ (LCO), LiNiMnCoO₂ (NMC), lithium iron phosphate (LiFePO₄), lithium ironfluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide, lithium vanadium oxide (LiV₂O₅), Li₂MSiO₄ wherein M is composed of any ratio of Co, Fe, and/or Mn, and a material that undergoes lithium insertion and deinsertion. In one embodiment, the negative electrode of the Li battery includes at least one of Li metal, graphite, hard or soft carbon, graphene, carbon nanotubes, titanium oxide, silicon (Si), tin (Sn), germanium (Ge), silicon monoxide (SiO), silicon oxide (SiO₂), tin oxide (SnO₂), transition metal oxide, and a material that undergoes intercalation, conversion or alloying reactions with lithium.

In one embodiment, he positive electrode of the Na battery includes at least one of NaMnO₂, NaFePO₄, and Na₃V₂(PO₄)₃.

In one embodiment, the positive electrode of the Mg battery includes at least one of TiSe₂, MgFePO₄F, MgCo₂O₄, and V₂O₅.

In one embodiment, the positive electrode of the Zn battery includes at least one of γ-MnO₂, ZnMn₂O₄, and ZnMnO₂.

In one embodiment, the negative electrodes of the Na, Mg and Zn batteries include Na metal, Mg metal, and Zn metal, respectively.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIGS. 1A-1D show schematic illustrations of the biomimetic ionic channels in MOFs, according to embodiments of this invention. FIG. 1A shows a Nations channel in biological systems with negatively charged glutamate ions [18]. FIG. 1B shows a structure of HKUST-1 made from copper nodes (blue) and BTC ligands (black) with pore channels of about 1.1 nm. FIG. 1C shows a schematic showing the formation of biomimetic ionic channels in HKUST-1 with ClO₄⁻ anions bound to the OMSs and solvated Li⁺ ions in the channels with high conductivity (copper: blue; carbon: black; oxygen: red). FIG. 1D shows a schematic of biomimetic ionic channels in a MOF scaffold (dark gray) with bound ClO₄⁻ ions (cyan dots), enabling fast transport of solvated Li⁺ ions (purple dots).

FIGS. 2A-2D show structure characterizations and lithium ion conductivity of LPC@MOFs electrolytes, according to embodiments of this invention. FIG. 2A shows a SEM image of HKUST-1 particles (insets: photographs of pristine HKUST-1, activated HKUST-1, and LPC@HKUST-1 electrolyte). FIG. 2B shows XRD patterns of pristine HKUST-1, activated HKUST-1, and LPC@HKUST-1 electrolyte. FIG. 2C shows Nyquist plots of various LPC@MOFs electrolytes at ambient temperature. ⋆: LPC@MIL-100-Al, ∘: LPC@MIL-100-Fe, ∇: LPC@UiO-67, [symbol] : LPC@HKUST-1, ⋄: LPC@MIL-100-Cr, Δ: LPC@UiO-66. FIG. 2D shows Arrhenius plots of various LPC@MOFs electrolytes and their calculated activation energies for lithium-ion conduction. FIG. 2E shows Arrhenius plots of LPC@MIL-100-Al (pink), LPC@MIL-100-Fe (dark yellow), and LPC@UiO-67 (cyan) in comparison with representative 1) ceramic electrolytes (Li₁₀GeP₂Si₂, garnet Li₇La₃Zr₂O₁₂, and LiPONLi_{3.5}PO₃N_{0.5}), 2) polymeric electrolytes (LiClO₄/PEO with TiO₂ additive [17], LiTFSI-PC in crosslinked SiO₂—PEO composites, and single ion polymer P(STFSILi)-PEO-P(STFSILi)), and 3) liquid-in-solid lithium-ion conductors, including liquid electrolyte@mesoporous silica, LiPF₆-EC/DMC/DEC@SiO₂ [30], LPC@organic porous solids, CB[6].0.4LiClO₄⁻.3.4PC [31], Li alkoxide@MOFs, Mg₂(dobdc).0.35LiOⁱPr.0.25LiBF₄.EC.DEC [23], and ionic liquid@MOFs, (EMI0.8Li_{0.2}) TFSA@ZIF-67 [32]; and 4) liquid electrolyte, 1 M LiClO₄ in PC (LPC).

FIGS. 3A-3D show spectroscopic investigation of LPC@MOFs electrolytes, according to embodiments of this invention. FIG. 3A shows Raman spectra of PC, LPC, PC@HKUST-1, and LPC@HKUST-1. FIG. 3B shows FT-IR spectra of PC, LPC, PC@HKUST-1, and LPC@HKUST-1. FIG. 3C shows Raman spectra of PC@MOF-5 and LPC@MOF-5. FIG. 3D shows comparisons of the activation energies of four LPC@MOFs electrolytes (LPC@HKUST-1, LPC@UiO-66, LPC@UiO-67, and LPC@MOF-5) and two liquid-in-solid conductors ((LPC@CB[6] [31] and LPC@MCM-48) vs. their pore sizes, indicating the effect of pore size and OMS on their activation energy. The pore size of LPC@UiO-66 and LPC@UiO-67 are averaged based the pore diameter of their bi-continuous pore channels.

FIGS. 4A-4J show electrochemical performance of LPC@MOF electrolyte and prototype lithium-based batteries, according to embodiments of this invention. FIG. 4A shows a cyclic voltammetry (CV) comparison between LPC@UiO-67 pellet and LPC electrolytes. FIG. 4B shows a flammability test of an LPC@UiO-67 electrolyte pellet. FIG. 4C shows a photograph of an LPC@UiO-67/PTFE membrane (denoted as LPC@UM) next to a coin cell (inset shows a bent LPC@UM). FIG. 4D shows SEM images of LPC@UM (top-left: cross-sectional view). FIG. 4E shows current-time profile for Li|LPC@UM|Li cell at 20 mV of polarization (inset: impedance spectra at initial and steady states). FIG. 4F shows Li symmetric cell test comparison between LPC@UM and LPC at a current density of 0.125 mA cm⁻² (0.25 mAh cm⁻²). FIG. 4G shows galvanostatic long-cycle stability tests at 1 C (1 C=170 mA g⁻¹, initially cycled at 0.2, 0.5, 1, and 2 C for five cycles each) of prototype LiFePO₄|Libatteries with LPC@UM electrolyte and LPC liquid electrolyte. FIG. 4H shows long-term cycling stability of prototype LiFePO₄|Li₄Ti₅O₁₂ batteries with LPC@UM electrolyte and LPC liquid electrolyte at 5 C (first two cycles at 1 C). FIG. 4I shows DC miropolarization of Li|LPC@UM|Li cell from 2.5 to 50 uA cm⁻². FIG. 4J shows Li symmetric cell test comparison between LPC@UM and LPC at a current density of 0.125 mA cm⁻² (0.25 mAh cm⁻²).

FIG. 5 shows N₂ adsorption/desorption isotherms of HKUST-1 and LPC@HKUST-1 electrolyte, according to embodiments of this invention.

FIG. 6 shows enlarged XRD patterns of as-prepared HKUST-1 (black), activated HKUST-1 (blue), and LPC@HKUST-1 (red). The coordination status of guest molecules on Cu^{II} metal sites is indicated by the 20 peak at 5.8°, according to embodiments of this invention.

FIG. 7 shows a TGA curve of LPC@HKUST-1 electrolyte in air, according to embodiments of this invention. Based on the result of ICP-AES, the formula of LPC@HKUST-1 is determined as Cu₃(BTC)₂(LiClO₄)_{2.8}(PC)ₓ. In the TGA measurement, the remaining weight (26.1%) corresponds to a mixture of CuO and LiCl, and the value of x can be deduced from the following equation:

26.1%/(3×M(CuO)+2.8×M(LiCl))=100%/M(Cu₃(BTC)₂(LiClO₄)_{2.8}(PC)ₓ), where M(CuO), M(LiCl), and M(Cu₃(BTC)₂(LiClO₄)_{2.8}(PC)ₓ) are the molecular weights of CuO, LiCl and the LPC@HKUST-1, respectively. Based on the calculated molecular weight of LPC@HKUST-1, the nominal formula is determined as Cu₃(BTC)₂(LiClO₄)_{2.8}(PC)_{4.6.}

FIGS. 8A-8C show SEM images with different scales, e.g., 100 μm in FIG. 8A, 10 μm in FIG. 8B and 1 μm in FIG. 8C, respectively, of a pressed LPC@HKUST-1 pellet used for the conductivity studies (inset of FIG. 4A: an electrolyte pellet), according to embodiments of this invention.

FIG. 9A shows Nyquist plots of LPC@HKUST-1 as a function of temperature, according to embodiments of this invention.

FIG. 9B shows N₂ adsorption/desorption isotherms of pyridine@HKUST-1, according to embodiments of this invention.

FIG. 9C shows Arrhenius plot of LPC@pyridine@HKUST-1 (inset: Nyquist plot of LPC-pyridine@HKUST-1 at room temperature), according to embodiments of this invention.

FIG. 10A shows a structure representation of two types of mesoporous cages in MIL-100 serial MOFs, according to embodiments of this invention.

FIG. 10B shows an illustration of OMS evolution in a metal trimer unit of MIL-100 serial MOFs (orange atoms Al/Cr/Fe, red atoms 0, grey atoms C, green atoms anionic ligands), according to embodiments of this invention.

FIGS. 10C-10H show characterizations of synthesized MIL-100 serial MOFs, according to embodiments of this invention. FIG. 10C shows XRD patterns. FIG. 10D shows N₂ adsorption/desorption isotherms. The analogous isotherms confirm the similar porous structure of the MIL-100 serial MOFs. There is a large non-negligible N₂ adsorption at relative high pressure for MIL-100-Cr, which corresponds to large interparticular porosity and is expected to be eliminated during preparation of electrolyte pellet. FIG. 10E shows FT-IR spectra together with the XRD patterns confirm the successful synthesis of isostructural MIL-100 materials. FIG. 10F shows a SEM image of MIL-100-Al. FIG. 10G shows a SEM image of MIL-100-Cr. FIG. 10H shows a SEM image of MIL-100-Fe.

FIG. 11A shows a topology structure of UiO-(66/67) serial MOFs, the purple polyhedra represent inorganic Zr₆O₄(OH)₄ clusters, the grey sticks manifest organic linkers (BDC and BPDC for UiO-66 and UiO-67, respectively), according to embodiments of this invention.

FIG. 11B shows a schematic illustration for activation of UiO-(66/67) serial MOFs (purple: Zr, red: O, blue: H), according to embodiments of this invention. OMSs are created by dehydration of Zr₆O₄(OH)₄ units.

FIGS. 11C-11E show characterizations of synthesized UiO-66, according to embodiments of this invention. FIG. 11C shows XRD patterns. Insets show the crystal structures of the corresponding MOFs. FIG. 11D shows N₂ adsorption/desorption measurements. FIG. 11E shows a SEM image.

FIGS. 11F-11H show characterizations of synthesized UiO-67, according to embodiments of this invention. FIG. 11F shows XRD patterns. Insets show the crystal structures of the corresponding MOFs. FIG. 11G shows N₂ adsorption/desorption measurements. FIG. 11H shows a SEM image.

FIG. 12A shows FT-IR spectra of pristine UiO-66, activated UiO-66 and LPC@UiO-66, according to embodiments of this invention.

FIG. 12B shows FT-IR spectra of pristine UiO-67, activated UiO-67 and LPC@UiO-67, according to embodiments of this invention.

FIG. 13 shows an Arrhenius plot of LPC liquid electrolyte and calculated activation energy for ionic conduction, according to embodiments of this invention.

FIG. 14A shows FT-IR spectra of PC and 1MLPC, according to embodiments of this invention.

FIG. 14B shows FT-IR spectra of PC@HKUST-1 and LPC@HKUST-1, according to embodiments of this invention.

FIG. 15 shows FT-IR spectra of Cu(ClO₄⁻)_{2.6}H₂O and Cu(ClO₄⁻)₂.xH₂O, where 2<x<4, according to embodiments of this invention.

FIG. 16A shows cubic structure of MOF-5 (Zn₄O(BDC)₃) in a ball-and-stick model (purple: Zn, red: oxygen, black: carbon), in which oxo-centered (μ₄-O) Zn₄ tetrahedra are interconnected through BDC to yield a highly porous framework with pore aperture of 8 Å and pore diameter of 12 Å [75, 76].

FIG. 16B shows N₂ adsorption/desorption isotherms of MOF-5, according to embodiments of this invention. The pristine MOF-5 exhibits higher BET surface area of 1810 m² g⁻¹ and pore volume of 0.75 cm³ g⁻¹ compared with HKUST-1.

FIG. 16C shows a SEM image of MOF-5, according to embodiments of this invention.

FIG. 16D shows XRD patterns of simulated, pristine, activated, and LPC infiltrated MOF-5, according to embodiments of this invention. The major crystal structure is unaltered, except for the change of a few peak intensities due to the presence of guest molecules [77].

FIG. 17 shows Arrhenius plots of LPC@CB[6] [78], LPC@MOF-5, and LPC@MCM-48. The plot of LPC@CB[6] is linearly fitted based on conductivity data reported in the reference, resulting in an activation energy different from the reported value.

FIGS. 18A-18B show synthesized MCM-48 mesoporous silica, according to embodiments of this invention. FIG. 18A shows N₂ adsorption/desorption isotherms. FIG. 18B shows BJH pore size distribution. MCM-48 was prepared according to a method reported in the literature [79].

FIG. 19A shows CVs of LPC@HKUST-1, according to embodiments of this invention.

FIG. 19B shows CVs of LPC@UiO-66, according to embodiments of this invention.

FIG. 20A shows a flammability test for a PP separator saturated with LPC, according to embodiments of this invention.

FIG. 20B shows a flammability test for an LPC@UiO-67 electrolyte pellet, according to embodiments of this invention.

FIGS. 21A-21E show Li symmetric cell comparison between LPC@UM electrolyte and LPC at (FIGS. 21A-21C) 0.25 mAh cm⁻² (0.125 mA cm⁻², red: LPC@UM electrolyte, black: LPC), (FIG. 21D) 0.5 mAh cm⁻² (0.25 mA cm⁻²), and (FIG. 21E) 1 mAh cm⁻² (0.5 mA cm⁻²), according to embodiments of this invention.

FIG. 22A shows voltage-capacity curves of LPC liquid electrolyte in LiFePO₄|Li cells at various rates, according to embodiments of this invention.

FIG. 22B shows voltage-capacity curves of LPC@UM electrolyte in LiFePO₄|Li cells at various rates, according to embodiments of this invention.

FIG. 23 shows tong-term cycling stability of prototype LiFePO₄|Li₄Ti₅O₁₂ batteries with LPC@UM electrolyte and LPC liquid electrolyte at 5 C (first two cycles at 1 C), according to embodiments of this invention.

FIG. 24 shows performance of a Li symmetric cell using LPC@UM electrolyte at 0.5 mAh cm⁻² (0.25 mA cm⁻²), according to embodiments of this invention.

### DESCRIPTION OF EMBODIMENTS

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in this disclosure, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this disclosure, the phrase “at least one of A, B, and C” should be construed to mean a logical (A or B or C), using a non-exclusive logical OR. As used herein, the term “and/or” includes any and all combinations of one or more of the associated listed items.

Embodiments of the invention are illustrated in detail hereinafter with reference to accompanying drawings. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

In lithium-ion battery operation, nonaqueous liquid electrolytes enable ion transport between redox active electrodes. The electrolyte chemistry involved here requires that polar solvents dissociate/dissolve the lithium salt which then allows facile ion transport via the fluidic medium. There are, however, certain limitations with current electrolyte systems. The thermal instability of organic solvents poses formidable concerns about safety, particularly for large-scale applications and Li metal-based secondary batteries. Moreover, the bulky size of solvated Li⁺ cations results in lower mobility relative to the anions. Consequently, during battery operation the effective current carried by the cations is mitigated by anion movement, leading to concentration polarization, battery life decay and inferior power output. Solid-state electrolytes overcome some of these deficiencies and are considered to be a promising direction for developing next-generation batteries due to improved safety and transport properties.

One aspect of this invention discloses a novel class of solid-state (or pseudo solid-state) electrolytes with biomimetic ionic channels, inspired by ionic channels in biological systems. This is achieved by complexing the anions of an electrolyte to the open metal sites (OMSs) of metal-organic frameworks (MOFs), which renders the MOF scaffolds into ionic-channel analogs with fast lithium-ion conductivity and low activation energy. The novel solid-state electrolytes are applicable to lithium-metal batteries.

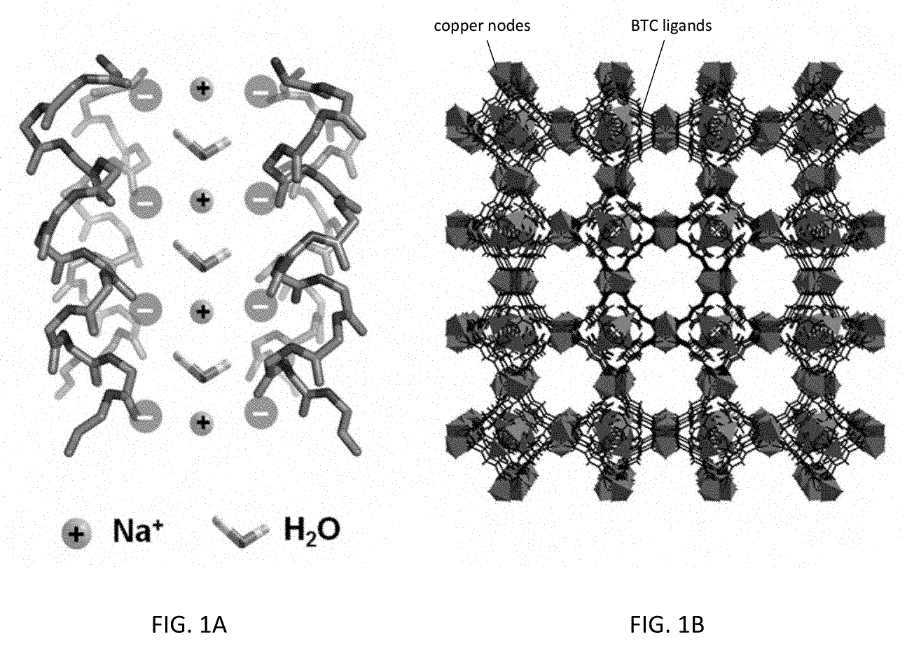

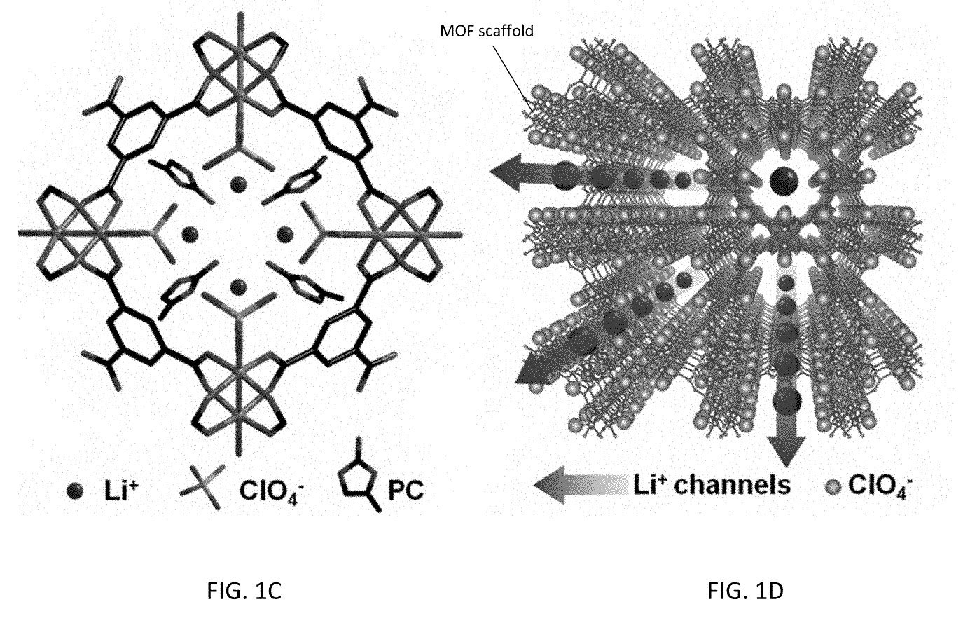

Ionic channels commonly exist in cell membranes and organelles, allowing selective permittivity of cations (e.g., H⁺, Na⁺, and K⁺) with little metabolic energy input [18]. FIG. 1A depicts a typical structure of Nation channels, of which the key components are the α-helix domains folded from glutamic-acid-rich peptide chains [19]. The carboxylic residues are deprotonated under the physiological environment (pH 7.4), forming negatively charged glutamate ions (—CH₂CH₂COO⁻) along the channels, which exclude anions (e.g., Cr) while allow effective transport of cations [18].

In certain embodiments, the novel solid-state (or pseudo solid-state) electrolytes with biomimetic ionic channels are constructed using metal-organic frameworks (MOFs) as scaffolds. This was first demonstrated using HKUST-1, one of the well investigated MOFs constructed from Cu (II) paddle wheels and benzene-1,3,5-tricarboxylate (BTC) ligands (linkers) [20]. As illustrated in FIG. 1B, HKUST-1 possesses three-dimensional (3D) pore channels with a pore diameter of about 1.1 nm. Similar to many other MOFs, HKUST-1 contains coordinated solvent molecules (e.g., water) along the channels. Removing the coordinated molecules (e.g, by activating HKUST-1 under vacuum at 200° C. for overnight) results in nanoporous HKUST-1 with unsaturated metal centers (i.e., open metal sites, OMSs) [21]. In the presence of LiClO₄ in propylene carbonate (PC), ClO₄⁻ ions spontaneously bind to the OMSs, forming ClO₄⁻-decorated MOFs channels, as shown in FIG. 1C. Soaking the activated MOFs in liquid electrolyte (e.g., LiClO₄ in propylene carbonate (PC)) allows the anions (e.g., ClO₄⁻) of the metal salt to bind to the unsaturated metal sites of the MOF and spontaneously form anion-bound MOF channels. In other words, the anions are bound to metal atoms of the MOF such that the anions are positioned within the pores of the MOF. Similar to the glutamate-like ionic channels, such negatively charged MOFs channels allow effective transport of Li⁺ ions with low activation energy, as shown in FIG. 1D.

It is noted that proton conductors have also been explored by loading MOFs with protonic inorganic (e.g., H₂O, H₂SO₄) or organic (e.g., imidazole, 1,2,4-triazole) molecules [22]. Lithium electrolytes were also synthesized from an MOF, Mg₂(dobdc), where dobdc is 1,4-dioxido-2,5-benzenedicarboxylate, by reacting Mg₂(dobdc) with lithium isopropoxide and subsequent infiltration with LiBF₄ in ethylene carbonate (EC) and diethyl carbonate (DEC), providing a lithium-ion conductivity of about 10⁻⁴ S cm⁻² [23, 24]. In another approach [25], MOF particles were mixed with an acrylate monomer to form composite membranes after polymerization, providing a lithium-ion conductivity below 10⁻⁵ S cm⁻¹. In these previous studies, there was no indication of whether ionic channels were involved in Li⁺ transport nor was there an indication that these MOF-related materials with ionic channels were able to serve as electrolytes in electrochemical devices.

In one aspect of the invention, the solid-state electrolyte includes a composite synthesized from an MOF material soaked in a liquid electrolyte, the MOFs being a class of crystalline porous solids constructed from metal cluster nodes and organic linkers.

In one embodiment, prior to soaking it into the a liquid electrolyte, the MOF material is activated under vacuum at a temperature greater than 150° C. for a period of time, e.g., overnight, so that the activated MOF material comprises OMSs that are corresponding to unsaturated metal centers created by activating pristine MOFs to remove guest molecules or partial ligands thereof.

In one embodiment, the MOF material comprises HKUST-1 having a formula of Cu₃(BTC)₂, MIL-100-Al having a formula of Al₃O(OH)(BTC)₂, MIL-100-Cr having a formula of Cr₃O(OH)(BTC)₂, MIL-100-Fe having a formula of Fe₃O(OH)(BTC)₂, UiO-66 having a formula of Zr₆O₄(OH)₄(BDC)₆, or UiO-67 having a formula of Zr₆O₄(OH)₄(BPDC)₆, wherein BTC is a benzene-1,3,5-tricarboxylic acid, BDC is a benzene-1,4-dicarboxylic acid, and BPDC is a biphenyl-4,4′-dicarboxylic acid.

In one embodiment, the liquid electrolyte comprises one or more non-aqueous solvents and metal salts dissolved in the one or more non-aqueous solvents. The one or more non-aqueous solvents are selected to match the surface properties of the MOF material. The metal salts are selected to have anions with desired sizes, which depends, at least in part, upon the MOF material, wherein the anion sizes are selected to ensure that the salts to infiltrate into at least some of the pores of the MOFs, and become immobilized therein to form the ionic conducting channels.

In one embodiment, the non-aqueous liquid electrolyte solvents comprise ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, cyclic ether compounds including at least one of tetrahydrofuran, 2-methyltetrahydrofuran, 1,3-dioxolane and dioxane, or a combination thereof.

In one embodiment, the metal salts comprise one or more of a lithium (Li) salt, a sodium (Na) salt, a magnesium (Mg) salt, and a zinc (Zn) salt,

In one embodiment, the liquid electrolyte comprises LiClO₄ and propylene carbonate, denoted as LPC.

In another aspect of the invention, the method for fabricating a solid-state electrolyte usable for ionic conductor for an electrochemical device includes: providing an MOF material, the MOFs being a class of crystalline porous solids constructed from metal cluster nodes and organic linkers; activating the MOF material under vacuum at a temperature greater than 150° C. for a period of time; soaking the activated MOF material in a liquid electrolyte to form a mixture; and filtrating the mixture and removing any excessive solvent to obtain the solid-state electrolyte in a free-flowing power form. In one embodiment, the period of time is more than 12 h.

In one embodiment, the method of further comprises pressing the power into pellets.

In one embodiment, the activated MOF material comprises OMSs that are corresponding to unsaturated metal centers created by activating pristine MOFs to remove guest molecules or partial ligands thereof.

In one embodiment, the MOF material comprises HKUST-1 having a formula of Cu₃(BTC)₂, MIL-100-Al having a formula of Al₃O(OH)(BTC)₂, MIL-100-Cr having a formula of Cr₃O(OH)(BTC)₂, MIL-100-Fe having a formula of Fe₃O(OH)(BTC)₂, UiO-66 having a formula of Zr₆O₄(OH)₄(BDC)₆, or UiO-67 having a formula of Zr₆O₄(OH)₄(BPDC)₆, wherein BTC is a benzene-1,3,5-tricarboxylic acid, BDC is a benzene-1,4-dicarboxylic acid, and BPDC is a biphenyl-4,4′-dicarboxylic acid.

In one embodiment, the liquid electrolyte comprises one or more non-aqueous solvents and metal salts dissolved in the one or more non-aqueous solvents, wherein the one or more non-aqueous solvents are selected to match the surface properties of the MOF material; and the metal salts are selected to have anions with desired sizes, which depends, at least in part, upon the MOF material, wherein the anion sizes are selected to ensure that the salts to infiltrate into at least some of the pores of the MOFs, and become immobilized therein to form the ionic conducting channels.

In one embodiment, the liquid electrolyte comprises LPC.

In yet another aspect of the invention, a composite electrolyte membrane usable for ionic conductor for an electrochemical device includes the solid-state electrolyte as disclosed above; and a binder mixed with the solid-state electrolyte.

In one embodiment, a concentration of the binder is in a range of 5-20 wt. % of the composite electrolyte membrane.

In one embodiment, the binder comprises poly-propylene (PP), poly-ethylene (PE), glass fiber (GF), polyethylene oxide (PEO), polyvinylidene fluoride (PVDF), polytetrafluoroethylene (PTFE), polyallylamine (PAH), polyurethane, polyacrylonitrile (PAN), polymethylmethacrylate (PMMA), polytetraethylene glycol diacrylate, or copolymers thereof.

In a further aspect of the invention, an electrochemical device has the composite electrolyte membrane as disclosed above; a positive electrode; and a negative electrode, wherein the composite electrolyte membrane is disposed between the positive electrode and the negative electrode.

In one embodiment, the electrochemical device is a lithium (Li) battery, a sodium (Na) battery, a magnesium (Mg) battery, or a zinc (Zn) battery.

In one embodiment, the positive electrode of the Li battery includes at least one of LiCoO₂ (LCO), LiNiMnCoO₂ (NMC), lithium iron phosphate (LiFePO₄), lithium ironfluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide, lithium vanadium oxide (LiV₂O₅), Li₂MSiO₄ wherein M is composed of any ratio of Co, Fe, and/or Mn, and a material that undergoes lithium insertion and deinsertion. In one embodiment, the negative electrode of the Li battery includes at least one of Li metal, graphite, hard or soft carbon, graphene, carbon nanotubes, titanium oxide, silicon (Si), tin (Sn), germanium (Ge), silicon monoxide (SiO), silicon oxide (SiO₂), tin oxide (SnO₂), transition metal oxide, and a material that undergoes intercalation, conversion or alloying reactions with lithium.

In one embodiment, he positive electrode of the Na battery includes at least one of NaMnO₂, NaFePO₄, and Na₃V₂(PO₄)₃.

In one embodiment, the positive electrode of the Mg battery includes at least one of TiSe₂, MgFePO₄F, MgCo₂O₄, and V₂O₅.

In one embodiment, the positive electrode of the Zn battery includes at least one of γ-MnO₂, ZnMn₂O₄, and ZnMnO₂.

In one embodiment, the negative electrodes of the Na, Mg and Zn batteries include Na metal, Mg metal, and Zn metal, respectively.

These and other aspects of the present invention are further described below. Without intent to limit the scope of the invention, exemplary instruments, apparatus, methods and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Synthesis of MOFs

Metal organic frameworks (MOFs) are a class of crystalline porous solids constructed from metal cluster nodes and organic linkers. The synthetic procedures of MOF typically involve hydrothermal method, as-prepared MOF pore channels are usually occupied by guest species (e.g. solvent molecules, like water or dimethylformamide). The removal of solvent species by activation creates vacant spaces to accommodate guest binary electrolyte. The colossal candidates of MOF are of particular interest due to their various metal centers, ligand derivatives and corresponding topology. Exemplary examples of synthesis of MOFs are described as follows.

Synthesis of HKUST-1.

HKUST-1 was synthesized according to a modified microwave-assisted method [66]. In a typical synthesis, 0.42 g of benzene-1,3,5-tricarboxylic acid (BTC) and 0.88 g of copper (II) nitrate trihydrate were dissolved in 24 mL solution of ethanol and water (volume ratio of 1:1). After continuous stirring for 20 min, the sample was transferred to a microwave reactor (Ultrawave, Milestone Inc.). The solution was heated at 800 W under nitrogen with a ramp rate of 10° C. per min before being held at 140° C. for 1 h. The product was collected by centrifugation and washed for further use.

Synthesis of MIL-100-(Al/Cr/Fe).

Isostructural MIL-100-(Al, Cr, Fe) MOFs were synthesized according to a modified microwave-assisted method [67]. For MIL-100-Al, 1.43 g of aluminum nitrate nonahydrate and 1.21 g of trimethyltrimesate were dispersed in 20 mL of water, followed by the addition of 4 mL of nitric acid (4 M). The mixture was transferred to the microwave reactor, heated at 1500 W to 240° C. in 6 min, and held for 1 min. For MIL-100-Cr, 2.4 g of chromium nitrate nonahydrate and 0.84 g of BTC were dispersed in 30 mL of water, followed by the addition of 5 mL of nitric acid (4 M). The mixture was heated in the microwave reactor at 1500 W to 200° C. in 10 min, and held for 5 min. For MIL-100-Fe, 2.43 g of iron (III) nitrate nonahydrate and 0.84 g of BTC were dispersed in 30 mL of water. The mixture was heated in the microwave reactor at 1500 W to 130° C. in 2 min 30 s, and held for 5 min. After the reactions, all of the samples were collected by centrifugation and washed several times for further use.

Synthesis of UiO-(66/67).

UiO-66 and UiO-67 were prepared according to a reported method [68]. In a typical synthesis of UiO-66 MOF, 1.23 g of BDC ligand and 1.25 g of ZrCl₄ were dissolved in 100 mL of N,N-dimethylformamide (DMF) and 50/10 mL of DMF/hydrochloric acid (37 wt % HCl, concentrated) mixture, respectively. These two fully dissolved solutions were combined and magnetically stirred for an additional 30 min. The resulting transparent precursor solution was loaded in a tightly sealed glass vial and heated at 150° C. for 20 h. Afterwards, the precipitate was separated from solvents by centrifugation and first washed by DMF three times (3×40 mL). Methanol exchange was performed on the DMF-washed sample over a period of 3 d. The sample was replenished with fresh methanol twice a day (each for 40 mL). Eventually the sample was dried at 80° C. for 1 d prior to further characterization. UiO-67 was prepared in a similar procedure with different reagents, in which 1.35 g of BPDC ligand and 1 g of ZrCl₄ were dissolved in 150 mL of DMF and 75/7.5 mL of DMF/HCl (37 wt % HCl, concentrated) mixture, respectively.

Synthesis of MOF-5.

MOF-5 was prepared by a room temperature synthesis [69]. In a typical synthesis, 17 g of zinc acetate dihydrate (Zn(OAc)₂.H₂O) and 5.1 g of BDC were dissolved in 500 mL of DMF and 400/8.5 mL of DMF/triethylamine mixture, respectively. Upon addition of the metal salt solution into the ligand solution, white precipitate forms immediately. After continuous stirring for 2.5 h, the precipitate was centrifuged and washed by DMF. Solvent change was carried out by immersing DMF-washed samples in chloroform (CHCl₃) and renewing the solvent once a day for one week. The resulting product was evacuated overnight and stored in a moisture-free environment for further use.

### Synthesis of Solid-State Electrolytes with High Ionic Conductivity

Synthesis of LPC@MOFs solid-state electrolytes. MOFs, including HKUST-1, UiO-(66/67), MIL-100-(Al/Cr/Fe), and MOF-5 were synthesized according to the reported literature and characterized by various techniques. The MOF samples were activated under vacuum at 200° C. (350° C. for MIL-100-Al and UiO-(66/67)) over night, subsequently soaked in the LiClO₄-PC (LPC) electrolyte, collected by vacuum filtration, and pressed into pellets with a diameter of 13 mm at 300 MPa. The surface of the pellets was wiped with tissue paper prior to further electrochemical tests.

Preparation of LPC@MOFs Electrolyte Membranes.

UiO-67 powders were homogeneously dispersed in ethanol, and 10 wt % polytetrafluoroethylene (PTFE) aqueous solution was added to the mixture. After continuous stirring and evaporation of the solvent, the mixture was rolled into flexible MOFs/PTFE composite membranes. The membranes were cut into a desirable size and subjected to the activation process and the soaking process. LPC@UiO-67/PTFE membrane electrolytes (LPC@UM) were pressed at 200 MPa to extrude any excessive liquid electrolyte and wiped with tissue paper.

Materials characterizations and structural analysis.

Crystalline structures of the MOFs and LPC@MOFs electrolytes were determined with a PanalyticalX'Pert Pro or a Rigaku powder X-ray diffractometer (XRD) using Kα radiation (X=1.54 Å). Surface morphology and particle size were determined by scanning electron microscopy (Nova 230 Nano SEM). (UV-VIS) Raman spectra were collected by a triple monochromator and detected with a charge coupled device (CCD). Pellets of samples were excited by an argon ion laser at a wavelength 457.9 nm at a laser power of 100 mW. The liquid samples were infused into capillary tubes for characterization. Infrared spectra experiments were performed in a transmission mode on a Jasco 420 Fourier transform infrared (FT-IR) spectrophotometer. Thermogravimetric analysis (TGA) was carried out in air atmosphere by a ramping rate of 5° C. min⁻¹. Copper and lithium ratio was determined by inductively coupled plasma atomic emission spectrometer (ICP-AES, Shimadzu, ICPE-2000) using standard copper and lithium solutions from Sigma-Aldrich. Calibration and quantitative analysis were carried out by a series of standard Cu/Li (5, 10, 20, 40 ppm) and 40 ppm LPC@HKUST-1 in 2 wt % HNO₃ solution.

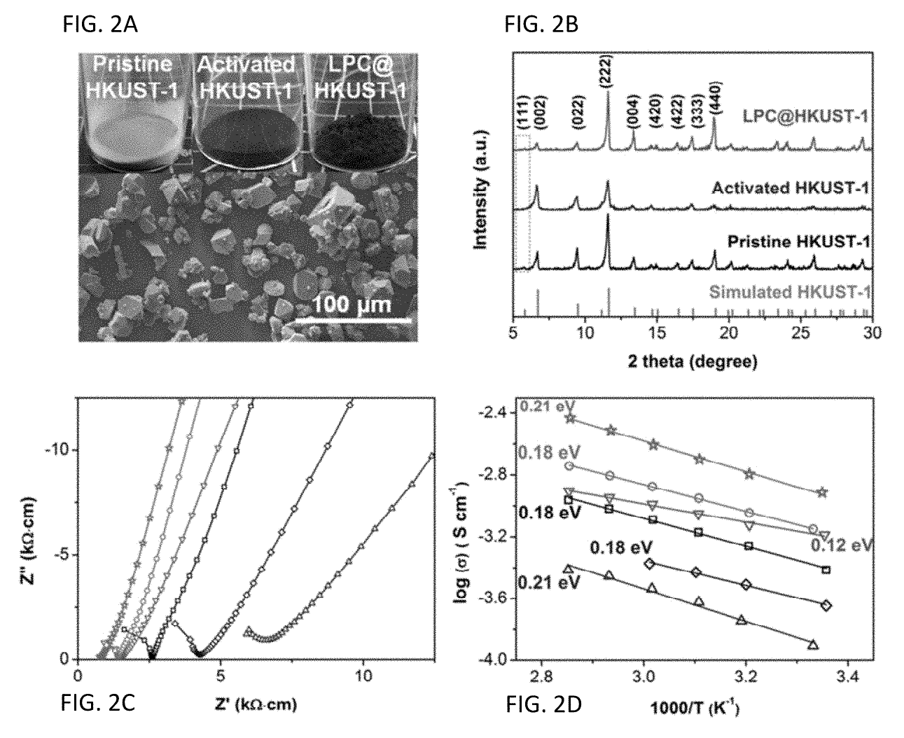

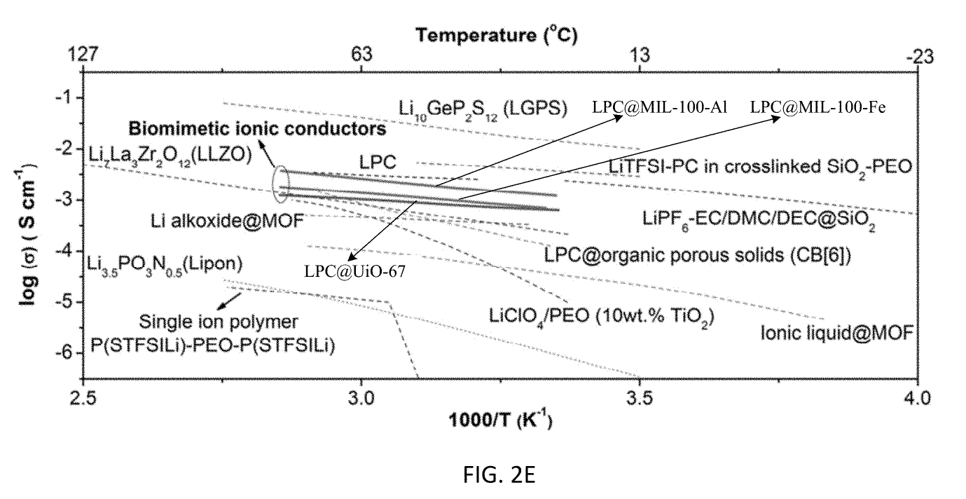

FIG. 2A presents a scanning electron microscope (SEM) image of the as-synthesized HKUST-1, which shows an average particle size of tens of micrometers and light blue color due to its water-coordinated copper centers. Removing the coordinated water (activation process) turns the color to dark purple, which then becomes dark cyan after soaking with a LiClO₄-PC solution (LPC), implying the emergence of unsaturated sites and re-coordination of the unsaturated sites with ClO₄⁻ ions, respectively (insets of FIG. 2A). The LPC-soaked HKUST-1 (denoted as LPC@HKUST-1) was collected after filtration and removal of any excessive solvent, showing a free-flowing power form.

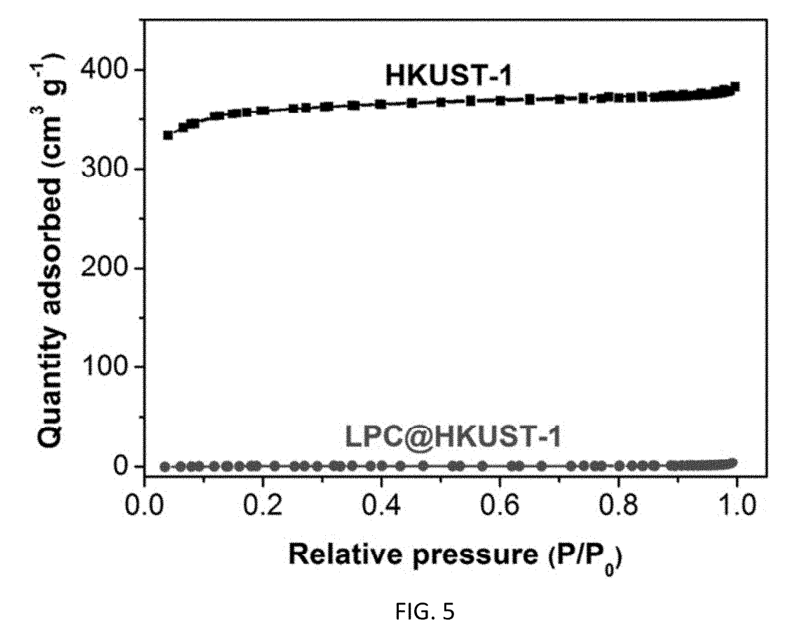

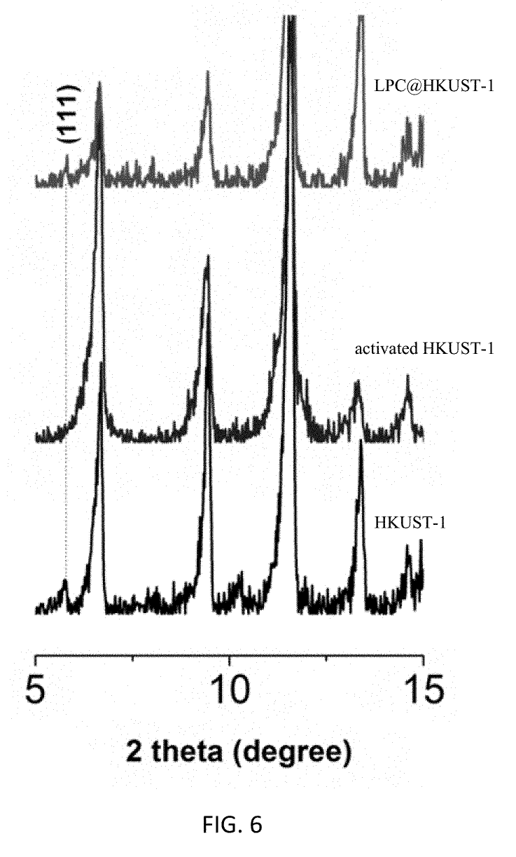

HKUST-1 exhibits a typical microporous structure with a surface area of about 1150 cm² g⁻¹ and a pore volume of about 0.5 cm³ g⁻¹, both of which decrease to near zero in LPC@HKUST-1, suggesting incorporation of LiClO₄ into the pore channels, as shown in FIG. 5. The crystalline structure of the HKUST-1 is well retained after the activation process and soaking with LPC as confirmed by the x-ray diffraction (XRD) patterns shown in FIG. 2B. The (111) peak disappears after the activation process and reappears after incorporating with LPC, which are consistent with removal of the coordinated water molecules, as shown in FIG. 6 [26] and binding of the OMSs with ClO₄⁻ ions, respectively.

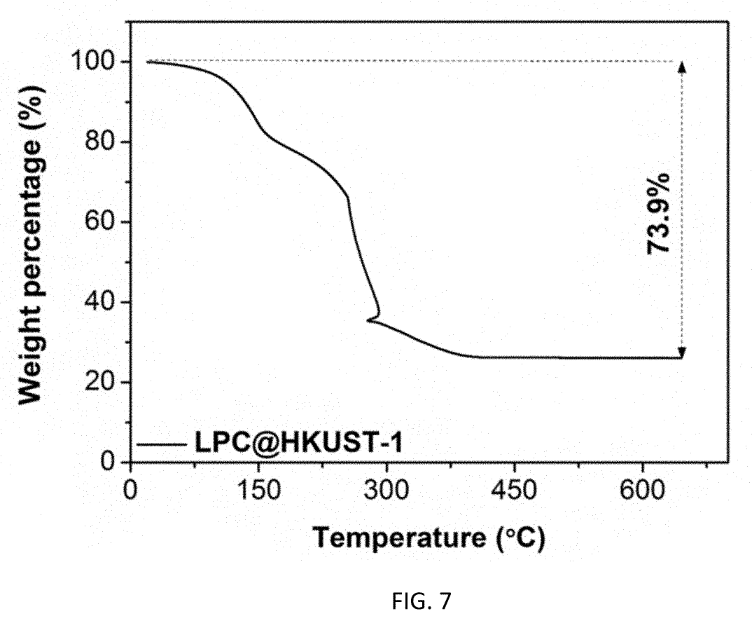

The composition of LPC@HKUST-1 was estimated by inductively coupled plasma atomic emission spectroscopy (ICP-AES) and thermogravimetric analysis (TGA). ICP-AES gives a Li/Cu molar ratio of about 0.94, which is consistent with our hypothesis that each ClO₄⁻ ion binds to an OMS (Cu center). Compared with the reported electrolyte based on Mg₂(dobdc), which possesses a Li/Mg molar ratio of about 0.3 [23], the concentration of Li⁺ ions in LPC@HKUST-1 is three-fold higher, which is important to provide high ionic conductivity. The content of PC within LPC@HKUST-1 is estimated by TGA, which gives a formula of LPC@HKUST-1 as Cu₃(BTC)₂(LiClO₄)_{2.8}(PC)_{4.6} (see details in FIG. 7). The low PC/Li molar ratio (about 1.6) suggests that each Li⁺ ion is solvated by less than two PC molecules, in sharp contrast to a much larger PC/Li ratio in LPC (approximately four PC molecules per Li⁺ ion) [27].

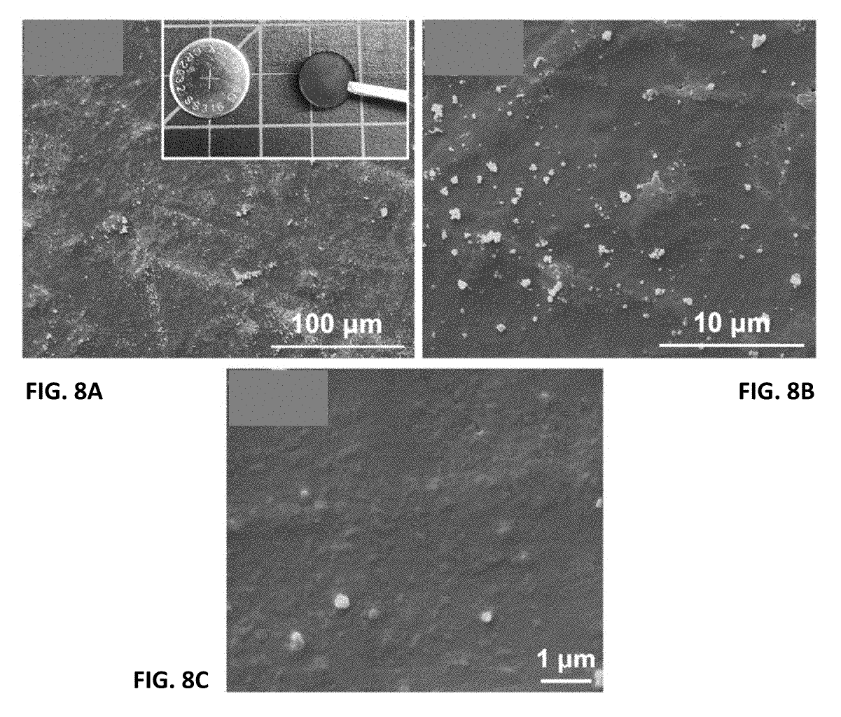

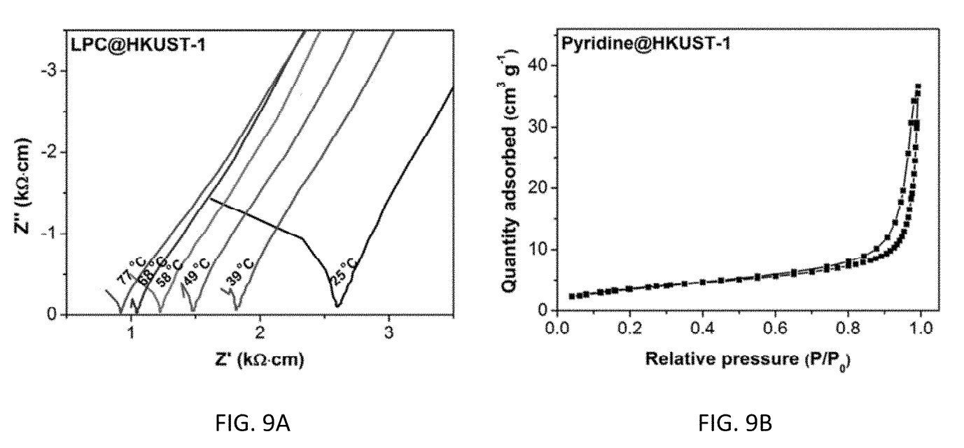

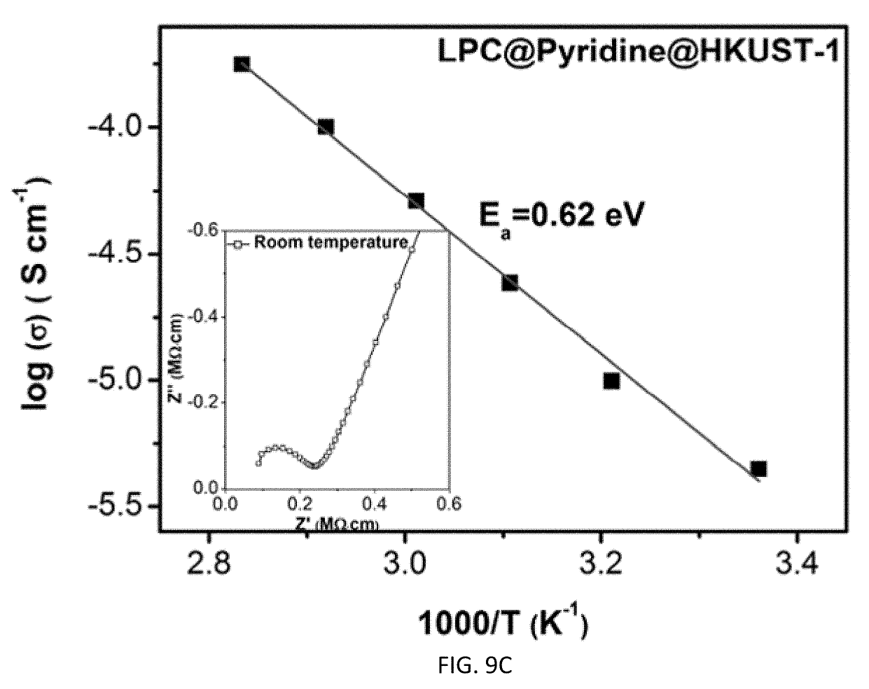

LPC@HKUST-1 powder was then pressed into dense pellets (inset of FIG. 8A) and sandwiched between two stainless steel plates in coin cells to measure the ionic conductivity. As shown in FIGS. 8A-8C, the pellets are free of notable cracks or interparticle voids as examined by SEM. The ionic conductivity of LPC@HKUST-1 was then measured by electrochemical impedance spectroscopy (EIS). FIG. 9A shows the Nyquist plots of the LPC@HKUST-1 pellets at various temperatures. Each plot includes a semi-circle in the high-frequency region and a spike in the low-frequency region, which correspond to the impedance from the bulk/grain boundary and blocking electrode, respectively [28]. Ionic resistance of the electrolytes was determined based on the intersect points of the semi-circles and the spikes. The conductivity of LPC@HKUST-1 at room temperature is determined as about 0.38 mS cm⁻¹, which is approximately one magnitude lower than that of liquid LPC, yet sufficiently high for device applications (FIG. 9B).

To address a possible concern that the as-measured ionic conductivity is mainly contributed by the LPC trapped within the intra-particular voids rather than by the ionic channels, activated HKUST-1 was pro-soaked with pyridine, a complex agent that strongly binds to the OMSs. After removing any excess pyridine, the pyridine-treated HKUST-1 (pyridine@HKUST-1) exhibit intra-particle void (pore volume about 0.05 cm³ g⁻¹), indicating an intra-particle void fraction of less than 5% assuming the density of the pyridine-treated HKUST-1 is about 1 g/cc (FIG. 9C). The pydridine@HKUST-1 was then infiltrated with LPC, and pressed into pellets (denoted as LPC@ pyridine@HKUST-1) using the same procedure for ionic conductivity measurement. In this design [29], the conduction of lithium ions through the ionic channels is inhibited while that through the intra-particular LPC is retained. As expected, a two-order lower ionic conductivity (about 10⁻³ mS cm⁻¹) (FIG. 9C) and three-fold higher activation energy (about 0.62 eV) (FIG. 9C) are obtained, confirming that the conductivity of LPC@HKUST-1 is mainly contributed by the ionic channels.

TABLE 1
MOFs selected to synthesize electrolytes with biomimetic ionic channels.

| | Formula | Ligand structure | Pore size (nm) |
|---|---|---|---|
| HKUST-1 MIL-100-Al MIL-100-Cr MIL-100-Fe | Cu₃(BTC)₂ Al₃O(OH)(BTC)₂ Cr₃O(OH)(BTC)₂ Fe₃O(OH)(BTC)₂ | 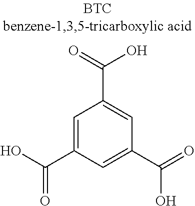 [SMILES: O=C(O)c1cc(C(=O)O)cc(C(=O)O)c1] | 1.1 2.5, 2.9 (windows: 0.6, 0.9) |
| UiO-66 | Zr₆O₄(OH)₄(BDC)₆ | 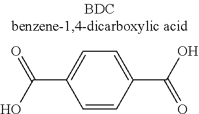 [SMILES: O=C(O)c1ccc(C(=O)O)cc1] | 0.75, 1.2 |
| UiO-67 | Zr₆O₄(OH)₄(BPDC)₆ | 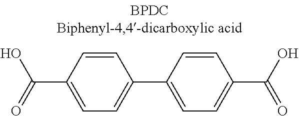 [SMILES: O=C(O)c1ccc(-c2ccc(C(=O)O)cc2)cc1] | 1.2, 2.3 |

In one aspect of the invention, this approach is generalized to synthesize a novel family of solid-state electrolytes using MOFs with different metal centers, organic linkers, and crystalline structures (see Table 1 for a list of selected MOFs), which are denoted as LPC@MOFs hereinafter.

In certain embodiments, MIL-100 serial MOFs (M₃O (BTC)₂OH.(H₂O)₂) are built from M³⁺ (M=Al, Cr, Fe) octahedra trimer sharing a common μ₃-O. Each M³⁺ is bonded to four oxygen atoms of bidendatedicarboxylate (BTC), and their linkage generates a hierarchical structure with mesoporous cages (25 and 29 Å) that are accessible through microporous windows (6 and 9 Å). The corresponding terminals in octahedra are generally occupied by removable guest molecules.

In certain embodiments, UiO-66 is obtained by bridging Zr₆O₄(OH)₄ inorganic clusters with BDC linkers (BDC=1,4-dicarboxylate). The Zr₆-octahedrons are alternatively coordinated by μ₃-O, μ₃-OH and O atoms from BDC, where μ₃-OH could undergo dehydration to form a distorted Zr₆₀₆ node (seven-coordinated Zr) upon thermal activation. UiO-67 has the same topology as UiO-66 with expanded pore channels due to the larger linker size of BPDC (BPDC=biphenyl-4,4′-dicarboxylate). Both UiO-66 and UiO-67 contain two types of pore size, small tetrahedral pore and large octahedral pore.

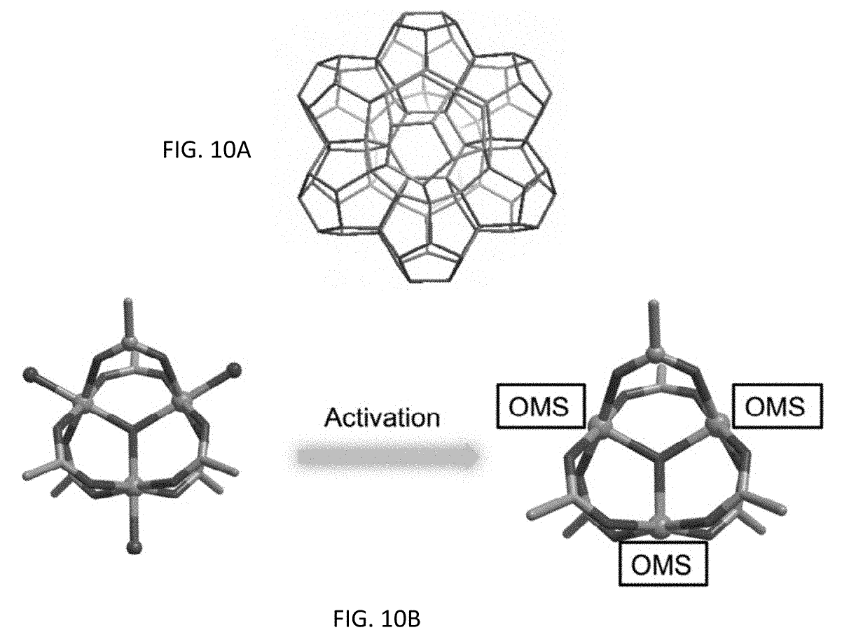

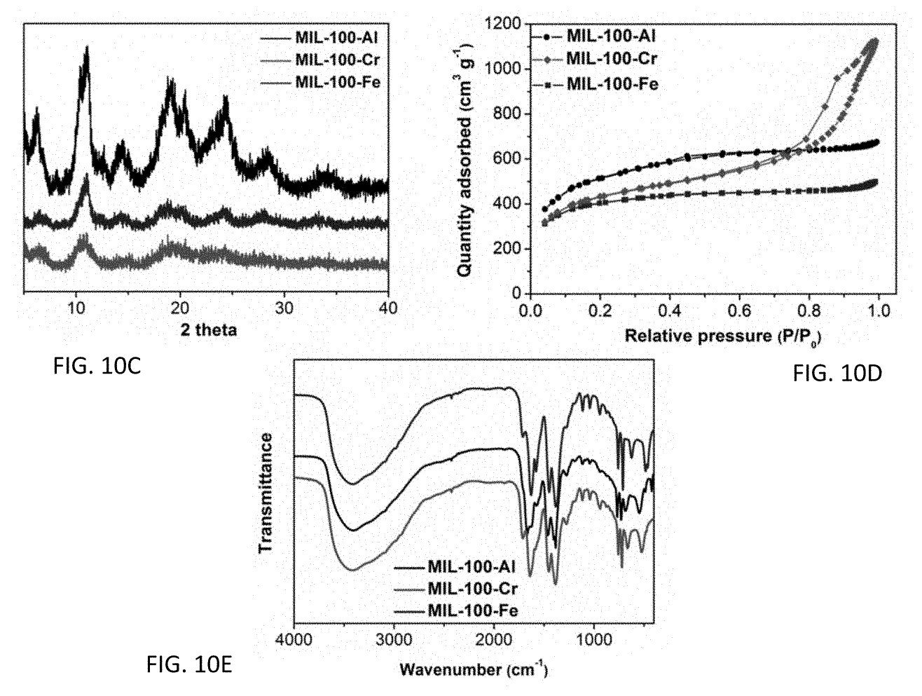

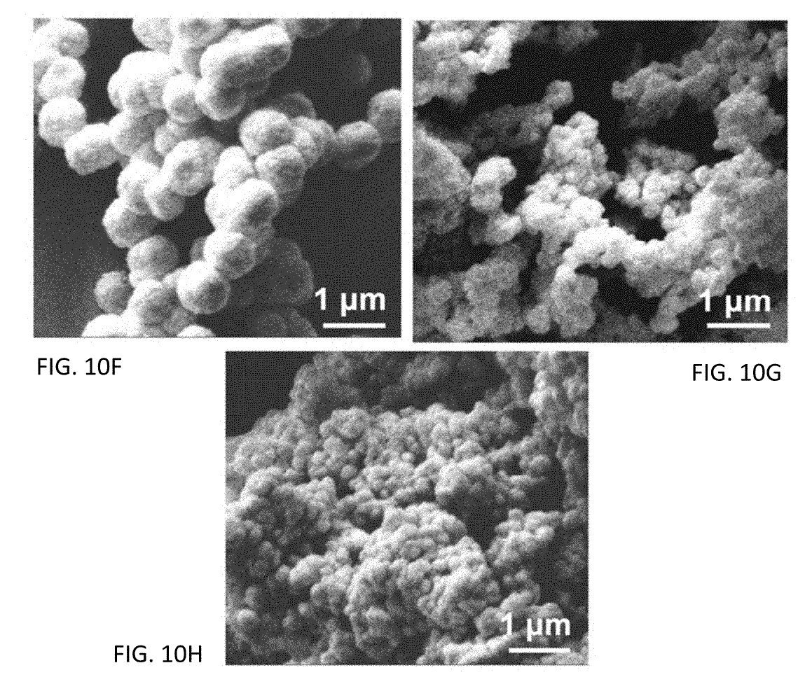

In certain embodiments, the Nyquist plots of the LPC@MOFs electrolytes at ambient temperature are displayed in FIG. 2C, and their conductivities are summarized in Table 2. In certain embodiments, two series of isostructural MOFs were selected to study the effect of OMS and pore size on ionic conductivity. MIL-100 MOFs (M30(BTC)₂OR(H₂O)₂, M=Al, Cr, Fe) are built from M³⁺ octahedratrinuclear units interconnected by BTC ligands, which exhibit an identical pore structure but with different OMSs, as shown in FIGS. 10A-10H, [33]. The electrolyte based on MIL-100-Al (LPC@MIL-100-Al) exhibits the highest ionic conductivity of over 1 mS cm⁻¹ at room temperature, which is in the same order of magnitude as commercial gel electrolytes [34]. The conductivities of two other electrolytes, LPC@UiO-67 and LPC@MIL-100-Fe, also lie in a satisfactory magnitude of over 0.5 mS cm⁻¹. It is found that the order of ionic conductivity of LPC@MIL-100-(Al/Cr/Fe) electrolytes is in line with the well-established Lewis acidity of OMS in the isostructural MIL-100-(Al/Cr/Fe) MOFs (Al>Fe>Cr) [35]. This result suggests that the stronger acidity of OMS leads to greater dissociation of ion pairings and enhances ion transport, implicating the critical role of OMS in the ionic conduction.

TABLE 2
Ambient conductivities and activation energies of
various LPC@MOF electrolytes.

| | Conductivity | Activation |
|---|---|---|
| LPC@MOF electrolyte | (mS cm⁻¹) | energy (eV) |
| LPC@MIL-100-Al | 1.22 | 0.21 |
| LPC@MIL-100-Fe | 0.9 | 0.18 |
| LPC@Ui0-67 | 0.65 | 0.12 |
| LPC@HKUST-1 | 0.38 | 0.18 |
| LPC@MIL-100-Cr | 0.23 | 0.18 |
| LPC@Ui0-66 | 0.18 | 0.21 |

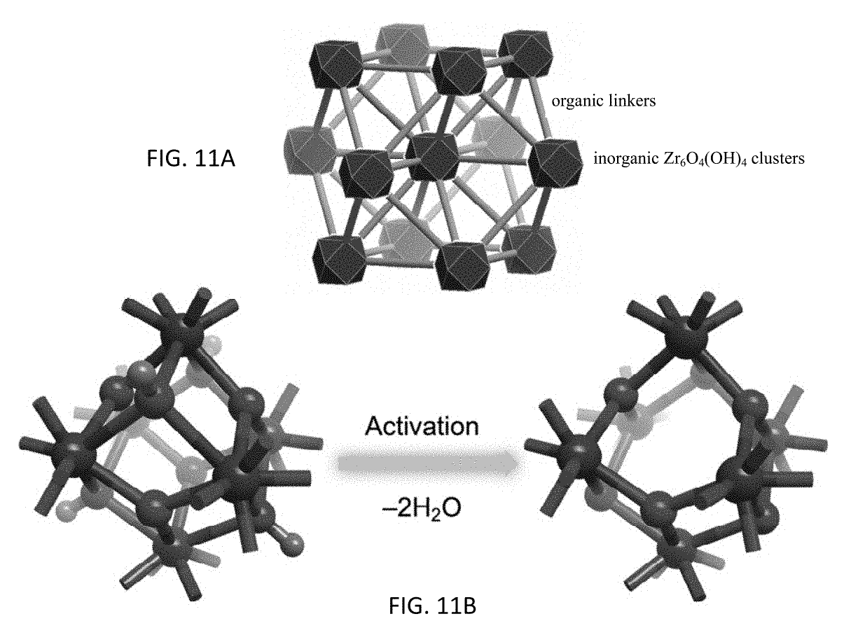

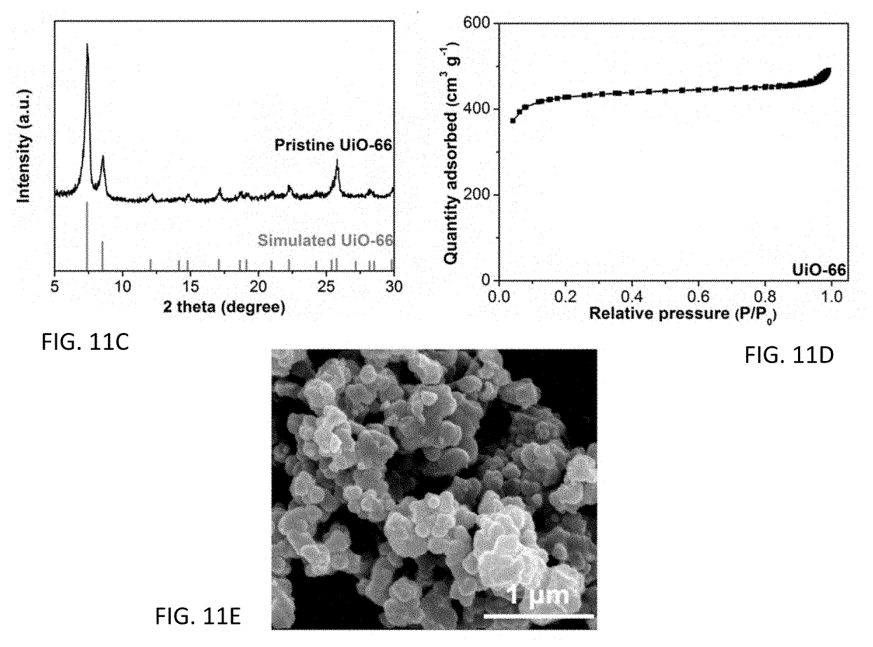

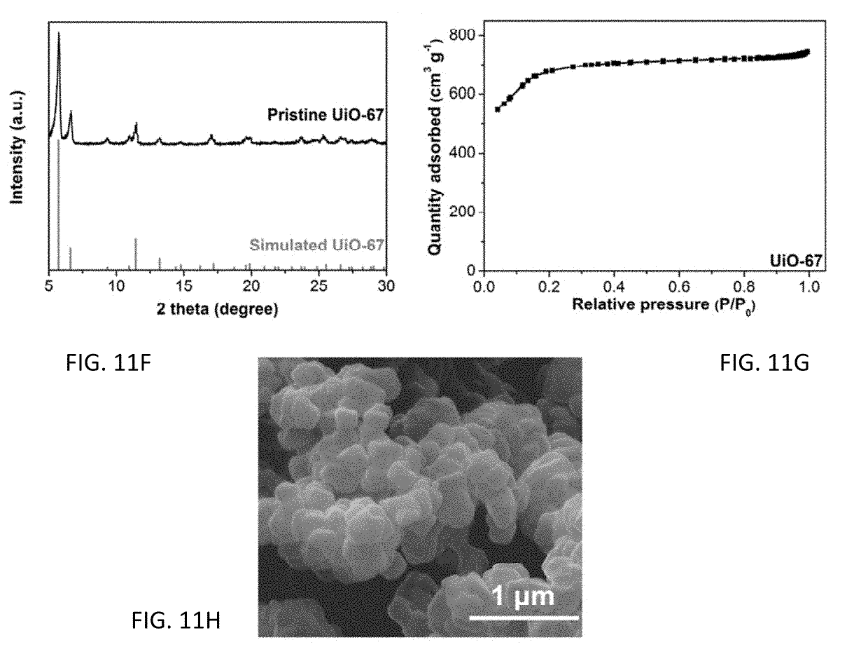

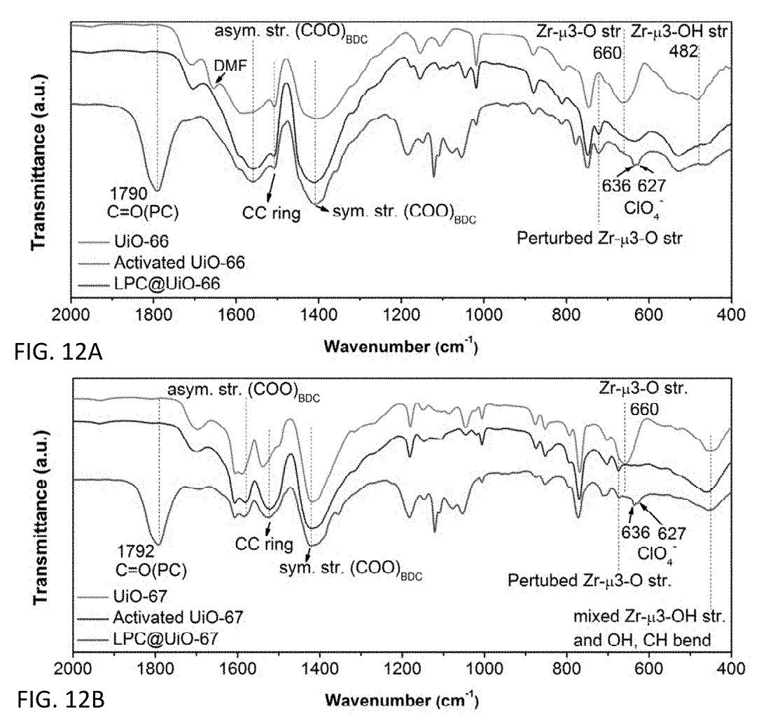

To examine the effect of pore size on ionic conductivity, UiO-66 (Zr₆O₄(OH)₄(BDC)₆, BDC=1,4-dicarboxylate) and UiO-67 (Zr₆O₄(OH)₄(BPDC)₆, BPDC=biphenyl-4,4′-dicarboxylate) were used as a model system. As depicted in Table 1 and FIG. 11A, both UiO-66 and UiO-67 are obtained by bridging the Zr₆O₄(OH)₄ cornerstones with BDC or BPDC linkers, possessing the same topology structure and OMS, but with different pore size. Upon activation, the Zr₆O₄(OH)₄ units (eight-coordinated Zr) undergo dehydration and the resulting Zr₆O₆ clusters (seven-coordinated Zr) possess unsaturated open Zr⁴⁺ sites (FIG. 11B). The UiO-66 exhibits bicontinous porous channels with a pore diameter of about 0.75 nm and about 1.2 nm, respectively; while UiO-67 shows a similar porous structure with a larger pore diameter of about 1.2 nm and about 2.3 nm, respectively (Table 1, FIGS. 11A-11H) [36]. It was found that LPC@UiO-67 exhibits a higher ionic conductivity (about 0.65 mS cm⁻¹ vs. about 0.18 mS cm⁻¹). The higher conductivity observed for UiO-67 is attributed by its larger pore channels that allow more effective solvation of the lithium ions with less confinement effect (FIGS. 12A-12B and Table 2).

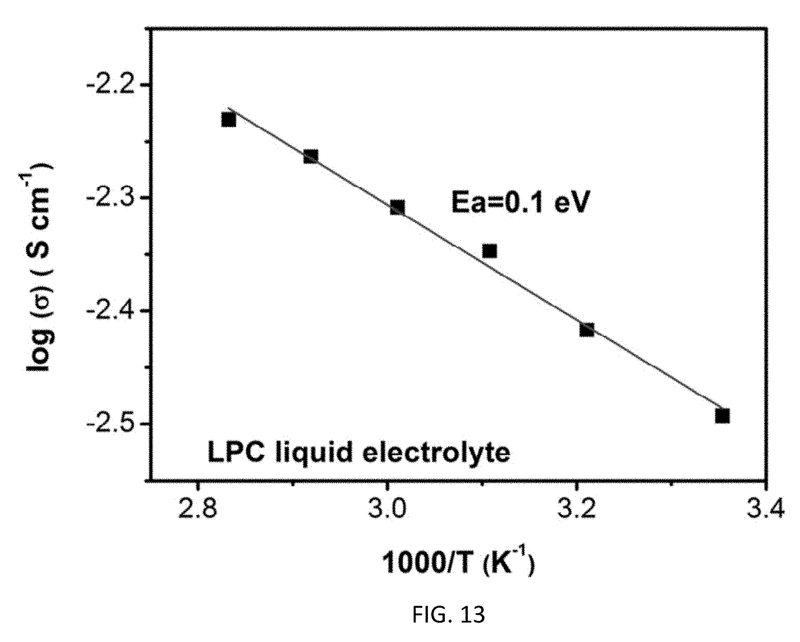

These electrolytes exhibit temperature-dependent conductivities with a typical Arrhenius-like behavior. Specifically, the activation energies measured are in the range of about 0.12-0.21 eV (FIG. 2D), which are slightly higher than that of LPC liquid electrolyte (0.10 eV, see FIG. 13) possibly due to confinement of the ions within the channels. Consistently, the conduction of lithium ions in LPC@UiO-67 shows a lower activation energy than that of LPC@UiO-66 (0.12 eV vs. 0.21 eV) due to its larger pore size, as listed in Table 3. The activation energies of these MOFs electrolytes are among the lowest activation energies reported for solid-state electrolytes, including the well-established ceramic electrolytes (e.g., Li₁₀GeP₂Si₂ (0.25 eV) [11], glassy Li₂S—P₂S₅ (0.19 eV) [37], and garnet Li₇La₃Zr₂O₁₂ (0.3-0.4 eV) [38]) and polymeric electrolytes (e.g., LiClO₄/PEO with TiO₂ additive (0.2-0.22 eV) [³⁹]).

FIG. 2E shows further comparisons of the ionic conductivity of LPC@UiO-67, LPC@MIL-100-Al, and LPC@MIL-100-Fe with other solid-state electrolytes that have been extensively studied. The conductivity of these electrolytes surpasses most polymeric electrolytes (e.g., LiClO₄/PEO with TiO₂ additive and PEO-based single ion polymer [40]), ceramic electrolytes (e.g., garnet Li₇La₃Zr₂O_{12 [38}], and LiPONLi_{3.5}PO₃N_{0.5} [41]), and liquid-in-solid lithium-ion conductors (e.g., LPC@organic porous solids [31], Li alkoxide@MOFs [23], and ionic liquid@MOFs [32]). With a conductivity higher than 10⁻⁴ S cm⁻¹ and an activation energy below 0.21 eV, such LPC@MOFs electrolytes can be classified as a new class of superionic solid-state electrolytes [42].

TABLE 3
Major peak assignments for pristine/activated UiO-(66/67) and LPC@UiO-(66/67) electrolytes.

| | | | Asym. | | | |
|---|---|---|---|---|---|---|
| | | | str. of | CC | | |
| | Zr-μ₃-OH | Zr-μ₃-O | (COO)_{BDC} | ring | (C═O)_{PC} | ClO₄— |
| Pristine UiO-66 | 482 | 660 | 1576(b) | 1506 | — | — |
| Activated UiO-66 | — | 720 | 1557 | 1506 | — | — |
| LPC@UiO-66 | — | 720(b) | 1559 | 1506 | 1790 | 627, 636 |
| Pristine UiO-67 | 457(*) | 660 | 1589 | 1540 | — | — |
| Activated UiO-67 | — | 675 | 1581 | 1522 | — | — |
| LPC@UiO-67 | — | 673 | 1584 | 1525 | 1792 | 627, 636 |

(*)Zr-μ₃-OH (457) assigned to UiO-67 is obscured by mixed —OH and —CH bend in the same range. (b)broadened peaks involving multi-components.

It is noted that UiO-66 and UiO-67 show similar trends in following aspects. (1) Owing to the removal of capping hydroxides at Zr metal centers after activation, those vibrations associated with Zr-μ₃-OH are eliminated, coupled with blue shifts of peaks pertaining to Zr-μ₃-O due to distorted local symmetry of Zr₆ clusters [70, 71]. After complexing with LPC, Zr-μ₃-O vibrations are either broadened or red shifted, signifying the symmetry recovery of Zr clusters due to introduced guest molecules. (2) Activation causes the red shift of asymmetric components of (COO) in BDC linkers. After complexing with LPC, those shifts are partially recovered. 3) Aside from a typical peak at 627 cm⁻¹ for characteristic ClO₄⁻ vibration in LPC, the ClO₄⁻ at LPC@UiO-(66/67) electrolytes exhibits significant breakdown of its tetrahedral symmetry, as evidenced by the emergence of new peaks at 636 cm⁻¹. The carboxyl (C═O) stretching of PC is indicative of Li⁺ solvation status by PC. The peak at 1792 cm⁻¹ for LPC@UiO-67 compared with 1790 cm⁻¹ for LPC@UiO-66 demonstrates weaker C═O (PC) interaction of Li⁺ within UiO-67 pore channels. It is believed that the slightly expanded pore channels of UiO-67 allow incorporation of more PC to leverage Li⁺ and ClO₄⁻ under nano-confinement, therefore affording higher ionic conductivity.

### Spectroscopic Investigation of Molecular Nature of Ionic Channels

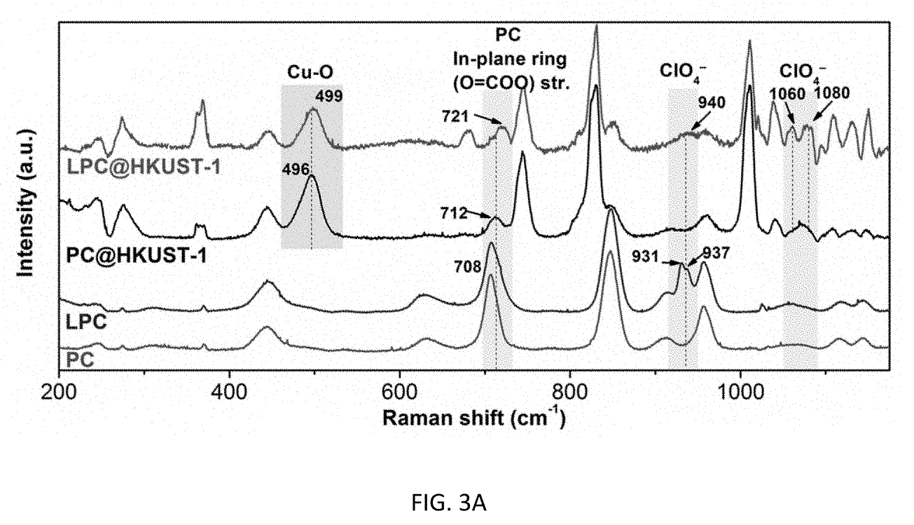

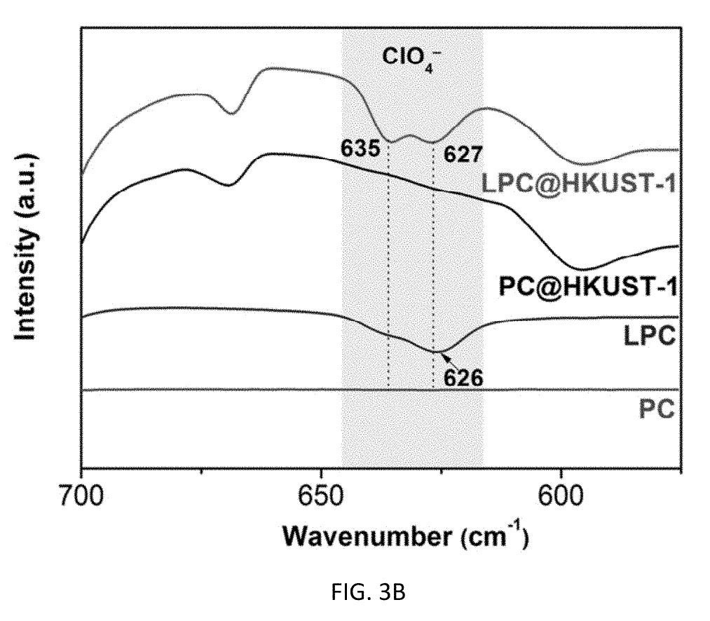

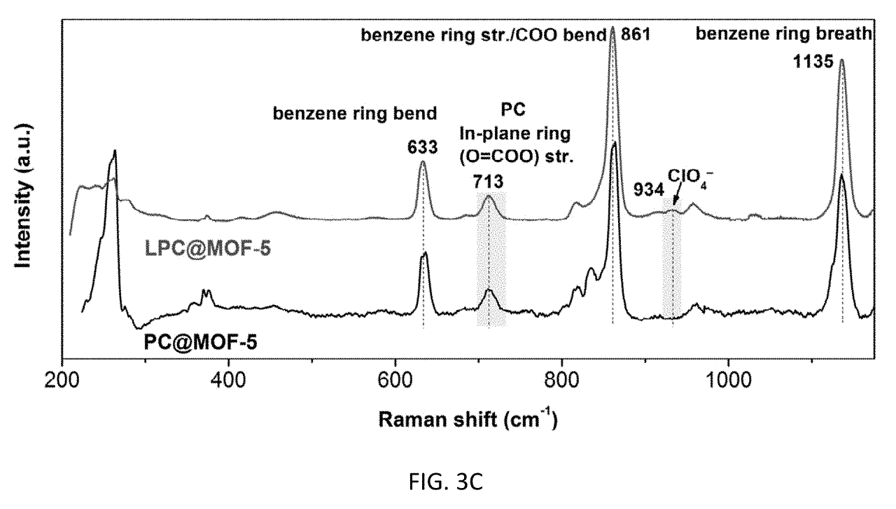

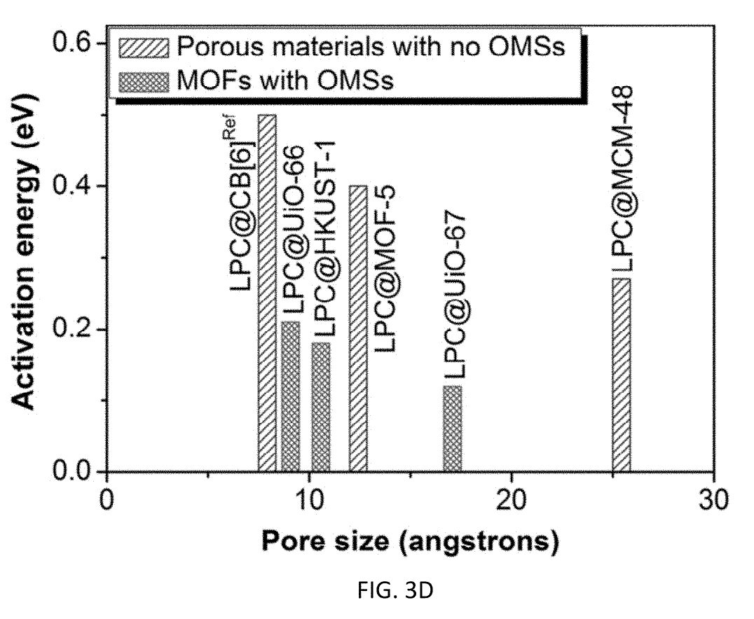

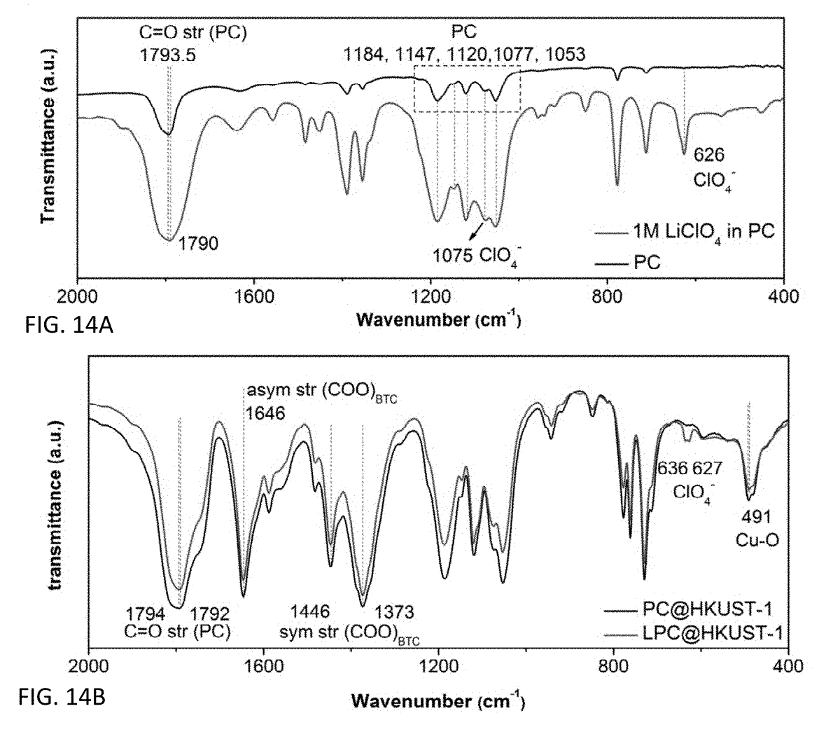

To understand the nature of such molecular assemblies that afford the LPC@MOFs with high ionic conductivity, Raman spectroscopy was utilized to probe their molecular interactions. FIG. 3A shows the Raman spectra of PC, LPC, HKUST-1 soaked with PC (denoted as PC@HKUST-1), and LPC@HKUST-1. Both PC@HKUST-1 and LPC@HKUST-1 show the featured peaks of HKUST-1 associated with the BTC ligands at 746 cm⁻¹, 832 cm⁻¹ and 1010 cm⁻¹, which agree well with the literature (see detailed assignments in Table 4) [43, 44]. Upon impregnating HKUST-1 with LPC, the peak ascribed the Cu—O (carboxylate oxygen atom from the ligands) vibration shifts from 496 cm⁻¹ to 499 cm⁻¹. These observations are consistent with the shortening/strengthening of the Cu—O bonds [44]. It manifests the perturbation of the ClO₄⁻ anions on the Cu sites, which then leads to alternations of molecular geometry and bond strength. The interactions between ClO₄⁻ anions and Cu sites is further supported by the color difference between PC@HKUST-1 and LPC@HKUST-1, as indicated by their UV-Vis spectra (FIGS. 14A-14B), and as a result of the change in the coordination sphere of the Cu^{II} ions [45].

TABLE 4
Detailed peak assignments for Raman spectra of PC, LPC, activated HKUST-1 [72], PC@HKUST-1,
and LPC@HKUST-1 (Peaks at 1041 cm⁻¹ are tentatively assigned to signals of ligands in HKUST-1)

| PC | LPC | HKUST-1 | PC@HKUST-1 | LPC@HKUST-1 | Assignments |
|---|---|---|---|---|---|
| — | — | 276 | 276 | 274 | Cu—Cu (HKUST-1) |
| 444 | 446 | 449 | 444 | 446 | O═COO (PC) bending + |
| | | | | | Cu—O (HKUST-1) |
| — | — | 505 | 496 | 499 | Cu—O (HKUST-1) |
| 708 | 708 | 722 | 712 | 721 | O═COO (PC) in-plane |
| | | | | | stretching + C—H |
| | | | | | out-of-plane |
| | | | | | bending of |
| | | | | | ring (HKUST-1) |
| — | — | 746 | 746 | 746 | C—OH out-of-plane |
| | | | | | bending of ring |
| | | | | | (HKUST-1) |
| — | — | 828 | 832 | 832 | C—H out-of-plane |
| | | | | | bending of ring |
| | | | | | (HKUST-1) |
| 850 | 850 | — | 850 | 850 | Symmetric stretching |
| | | | | | of PC ring |
| — | 931, 937 | — | — | 940 | v₁ vibration mode |
| | | | | | of ClO₄— |
| 959 | 959 | — | 960 | 960 | In-plane PC ring |
| | | | | | stretching |
| — | — | 1008 | 1010 | 1010 | Symmetric stretching |
| | | | | | (C═C) of benzene ring |
| | | | | | (HKUST-1) |
| — | — | — | — | 1060, 1080 | v₃ vibration mode |
| | | | | | of ClO₄— |
| 1058, 1116, | 1058, 1116, | — | 1070, 1109, | 1070, 1109, | O═COO (PC) in-plane |
| 1144 | 1144 | | 1131, 1150 | 1131, 1150 | stretching |

The Raman spectra related to PC provide further insights into the interactions between the MOFs and LPC. PC exhibits a well-resolved peak at 708 cm⁻¹⁻, originating from the characteristic PC in-plane carbonyl (O═COO) stretching [46]. Upon addition of LiClO₄, LPC shows a broadened carbonyl stretching peak at 708 cm⁻¹ due to its solvation with Li⁺ ions [46, 47]. The emerging peaks at 931 cm⁻¹ and 937 cm⁻¹ represent the vi symmetric vibrational stretch of ClO₄⁻ and ClO₄⁻ paired with Li^{t}, respectively [48]. Since the carbonyl stretching is sensitive to the surrounding environment, the Raman shift of stretching increases from 708 cm⁻¹ for PC to 712 cm⁻² for PC@HKUST-1, indicating their interaction with the MOFs scaffolds. The frequency of the carbonyl stretching further increases to 721 cm⁻¹ for LPC@HKUST-1, implying stronger solvation of Li⁺ ions within the channels [47]. In addition, carbonyl stretching of free PC is barely observed in LPC@HKUST-1, further confirming the incorporation of PC and LiClO₄ within the channels.

The perchlorate group has a built-in spectroscopic handle that enables determination of the complexation state when coordinated to the Cu metal centers. As perchlorate becomes coordinated to the OMS, the original T_{d} symmetry of perchlorate is reduced to C₃ₓ and then C₂ₓ for monodentate and bidentate perchlorate, respectively (see Table 5). Consistent with the enhanced Li⁺ solvation, the peaks associated with free ClO₄⁻ at 931 cm⁻¹ and Li⁺—ClO₄⁻ ion-pairs at 937 cm⁻¹ disappear in LPC@HKUST-1, and a new peak appearing at 940 cm⁻¹ indicates the coordination of ClO₄⁻ to the OMS [46, 48-52]. For PC@HKUST-1, the peaks at 1070 cm⁻², 1109 cm⁻¹, 1131 cm⁻¹⁻, and 1150 cm⁻¹ pertain to the stretching and bending of the PC molecules. In LPC@HKUST-1, an emergence of two well-resolved peaks at 1060 cm⁻¹ and 1080 cm⁻¹ is attributed to the breakdown of ClO₄⁻ symmetry, which is regarded as evidence for the coordination of ClO₄⁻ to Cu^{II} complex according to reported literature [53-57].

TABLE 5
Vibration of ClO₄ group as a function of symmetry [73, 74].^{a}

| | | Coordi- | | | | |
|---|---|---|---|---|---|---|
| | | nation | | | | |
| State of ClO₄ | Symmetry | state | Vibration mode | | | |
| 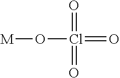 | C₃ᵥ | Mono- dentate | A1 | E | A1 + E | A1 + E |
| 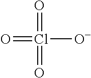 | T_{d} | Unco- ordinated | v₁ A (931 cm⁻¹) | v₂ E^{b} (460 cm⁻1) | v₃ F2 (1100 cm⁻¹) | v₄ F2 (626 cm⁻¹) |
| 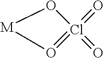 | C₂ᵥ | bidentate | A1 | A1 + A2^{b} | A1 + B1 + B2 | A1 + B1 + B2 |

^{a}A and B, non-degenerate; E, doubly degenerate; F, triply degenerate.
^{b}Infrared disallowed.

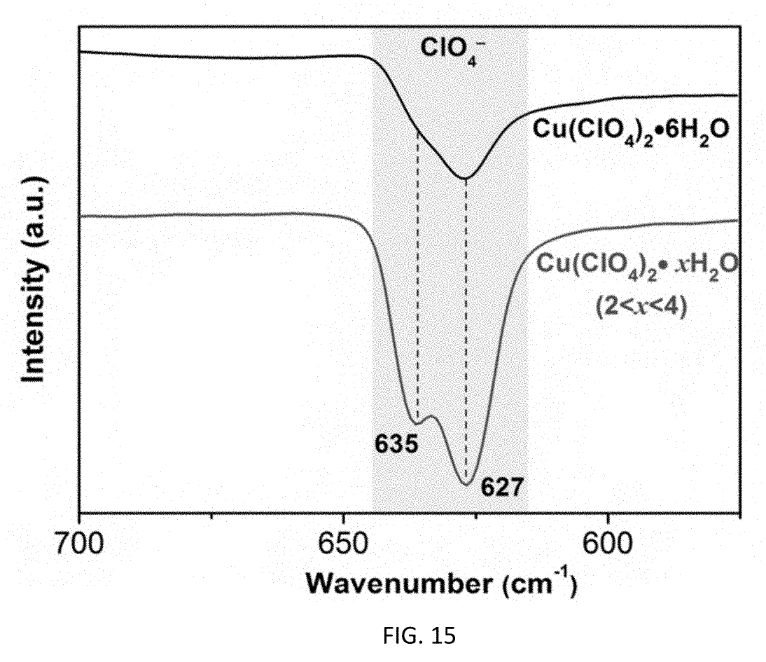

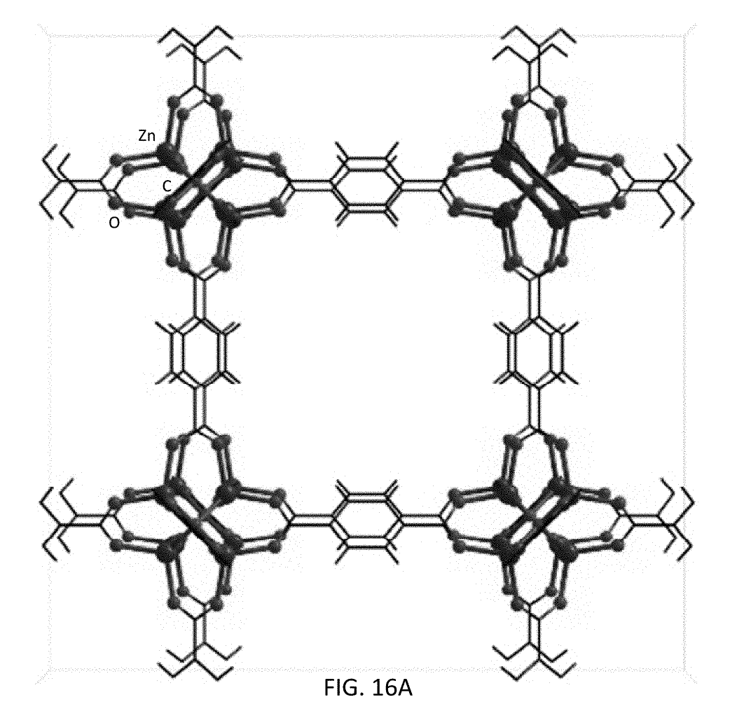

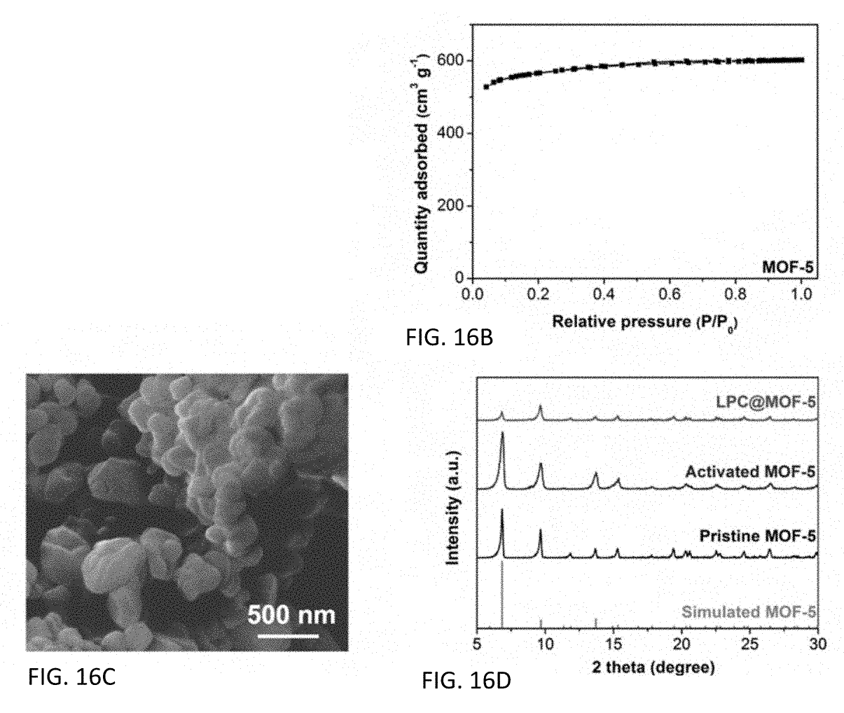

The complexation of ClO₄⁻ with OMS is further confirmed by FT-IR. FIG. 3B shows the FT-IR spectra for PC, LPC, PC@HKUST-1, and LPC@HKUST-1 (see full spectra in FIG. 15). LPC shows a sharp peak at 626 cm⁻¹, which arises from the symmetric vibration of the ClO₄⁻ ions. LPC@HKUST-1 exhibits two distinct ClO₄⁻ peaks at 635 cm⁻¹ and 627 cm⁻² due to its interaction with the OMS. To confirm this observation, cooper (II) perchlorate hexahydrate (Cu(ClO₄⁻)_{2.6}H₂O) was heated to remove crystalline water, resulting in complexation of ClO₄⁻ to the copper centers. As compared in FIGS. 16A-16D, the FT-IR spectrum of Cu(ClO₄⁻)_{2.6}H₂O shows the ClO₄⁻ peak at 627 cm⁻¹. During the dehydration process, ClO₄⁻ coordinates to the Cu(II) sites, creating an additional peak at 635 cm⁻¹. This analogous scenario constitutes strong evidence that the peak at 635 cm⁻¹ in LPC@HKUST-1 is associated with the breakdown of the symmetric structure of free ClO₄⁻ and its coordination to OMS [56, 58, 59].

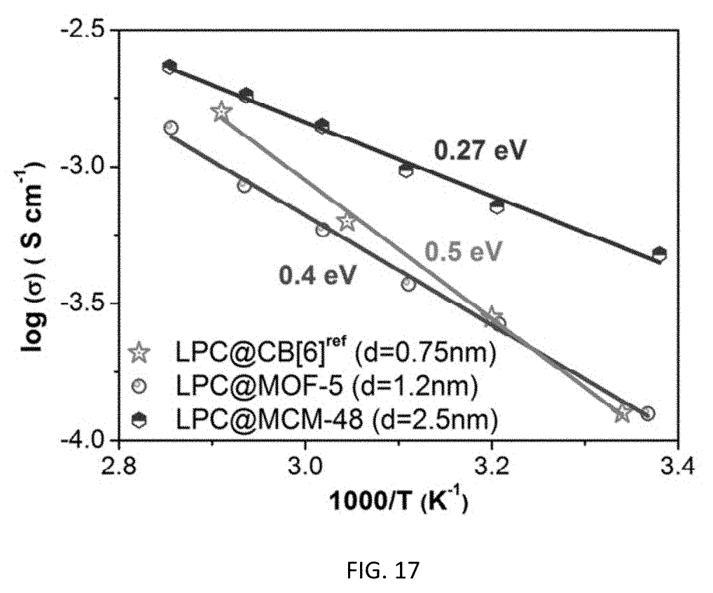

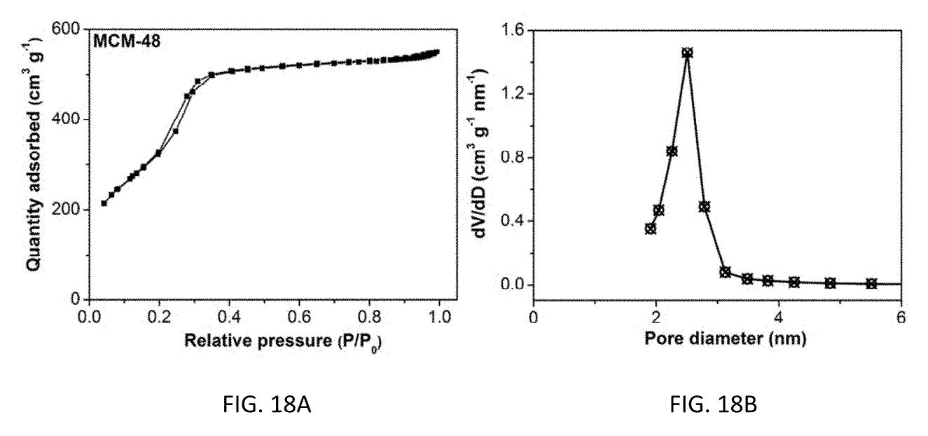

The spectroscopic studies clearly suggest that OMSs do play essential roles in ionic conduction. To experimentally verify this finding, an electrolyte analogue was prepared using MOF-5 (Zn₄O(BDC)₃), which possesses a similar pore diameter (about 1.2 nm) to that of HKUST-1 (about 1.1 nm) but contains no OMS, as shown in FIG. 17. Compared with LPC@HKUST-1, LPC@MOF-5 shows inferior ambient ionic conductivity of 0.13 mS cm⁻¹ (FIGS. 18A-18B). FIG. 3C shows further comparisons of the Raman spectra of PC@MOF-5 and LPC@MOF-5, where the stretching at 934 cm⁻¹ in LPC@MOF-5 indicates ion pairing between ClO₄⁻ and Li⁺. This observation confirms the essential role of OMSs, which coordinate with anions to form negatively charged ionic-channel analogs.

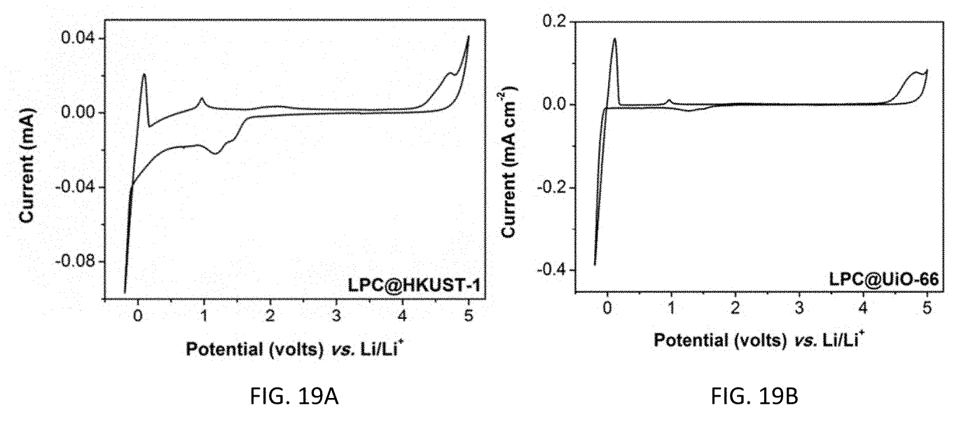

FIG. 3D shows further comparisons of the activation energies of four LPC@MOFs electrolytes (LPC@HKUST-1, LPC@UiO-66, LPC@UiO-67, and LPC@MOF-5) and two liquid-in-solid electrolytes (LPC@CB[6] [31] and LPC@MCM-48). The pore sizes of LPC@CB[6], LPC@UiO-66, LPC@HKUST-1, and LPC@MOF-5 are in a similar range. Nevertheless, those with OMSs show significantly lower activation energy. For example, LPC@MOF-5 (pore size of 1.2 nm) and LPC@CB[6] [31] (pore size of 0.75 nm) show an activation energy of 0.4 eV and 0.5 eV, respectively, which is more than twice that of LPC@HKUST-1 (0.18 eV) with a pore size of 1.1 nm (FIGS. 18A-18B) and LPC@UiO-66 (0.21 eV) with an average pore size of 1 nm. A similar phenomenon is found between LPC@UiO-67 (pore size of 2.3 nm with OMSs) and mesoporous silican LPC@MCM-48 (pore size of 2.5 nm without OMS), where LPC@MCM-48 exhibits a notably higher activation energy (about 0.27 eV) than LPC@UiO-67 (about 0.12 eV) (FIGS. 19A-19B). Furthermore, the activation energy of the electrolytes with OMSs (LPC@UiO-66, LPC@HKUST-1, and LPC@UiO-67) decreases with increasing pore size. Similarly, the activation energy of the electrolytes without OMS (LPC@CB[6], LPC@MOF-5, and LPC@MCM-48) decreases with increasing pore size. Therefore, it is reasonable to conclude that OMSs and large pore facilitate the transport of lithium ions with low activation energy.

It is shown that lithium-ion transport could be effectively rectified by nanoporous Al₂O₃ membranes (pore diameter of about 20-200 nm) filled with liquid electrolyte [60]. When the pore diameter is less than five times the Debye screening length, transport of the counter anions is impeded by the charged pore walls, resulting in increased Li⁺ transference number t_{Li}⁺. For example, with a dilute electrolyte containing about 1 mM of LiTFSI in dioxolane (DOL) and dimethoxyethane (DME) with a Debye screening length of about 2-3 nm, a rectifying effect was observed for membranes with a pore diameter of about 20 nm. However, such rectifying effect disappears at high concentrations of electrolyte (e.g., 1.0 M, a concentration used in commercial lithium-ion batteries) due to decreased Debye length (e.g., about 5.7 Å for 1.0 M LPC) [61]. Nevertheless, compared with the nanoporous Al₂O₃ membranes, most MOFs-based electrolytes possess much smaller pore channels (<2 nm in diameter), ensuring effective screening out of anions even in the presence of a high concentration of salt.

In short, the conduction of lithium ions in the MOFs electrolytes is attributed to the biomimetic ionic channels, which are constructed through spontaneous complexing of electrolyte anions to the OMSs within the MOFs channels filled with solvent molecules. Complexing of anions with OMSs creates ionic channels with a negatively charged surface, of which the Debye screening length is comparable to or exceeds the pore sizes of most MOFs. Such complexing structure weakens the interactions between Li⁺ cations and the anions, enabling fast conduction of Li⁺ ions through the channels. Stronger interactions between the OMSs and the anions, and larger pore sizes lead to electrolytes with higher ionic conductivity and lower activation energy. A series of experiments were then designed to characterize some of the electrochemical properties, one of the MOF electrolytes, LPC@UiO-67, in view of its high ionic conductivity and high stability. For practical purposes, the MOF electrolyte was fabricated into a flexible membrane by mixing it. Collectively, such biomimetic ionic channels enable fast ion conduction within the MOFs electrolytes.

### Electrochemical Performance of Electrolytes

Ionic conductivity was measured using electrochemical impedance spectroscopy (EIS) after placing the pellets between two stainless steel blocking contacts in a 2032-type coin cell. The conductivity of LPC liquid electrolyte was collected by saturating a glass fiber membrane (Whatman, GF-C) with LPC. The frequency range was from 10⁶ to 1 Hz, and alternating-current (AC) amplitude was 100 mV. Ionic conductivity (σ, S cm⁻¹) was determined by using the end point of the semi-circle as the ionic resistivity (R, ohm), thickness (L, cm), and area of the pellet (S, cm²) based on σ=L/(R×S). To measure the activation energies, conductivity was measured at different temperatures and calculated based on the Arrhenius relation with a linear fitting coefficient over 0.99.

For cyclic voltammetry (CV) tests, lithium foils were utilized as reference electrodes and stainless-steel plates were used as the working/counter electrodes. The CV of LPC@MOFs pellets were performed between −0.2 and 5 V at 0.5 mV s⁻¹. All voltammetry and impedance measurements were conducted on a Solartron 1860/1287 electrochemical interface. LPC@UiO-67/PTFE electrolyte membranes (LPC@UM) were used to assemble symmetric cells, LiFePO₄Li cells, and LiFePO₄|Li₄Ti₅O₁₂ cells. Lithium symmetric cells were assembled by sandwiching LPC@UM electrolyte between two pieces of lithium foil in a coin-cell; a single drop (about 6 ul) of electrolyte was delivered to the electrolyte/electrode interface. The Li stripping/plating tests were performed using the symmetric cells by charging and discharging for a periodic 2 h each at current densities of 0.125, 0.25 and 0.5 mA cm⁻².

Lithium ion transference number (t_{Li+}) was measured by combining an AC impedance measurement and a potentiostatic polarization measurement using Li/electrolyte/Li cells. First, an AC impedance test (10⁶ to 1 Hz, 20 mV amplitude) was performed to obtain the initial bulk resistance (R_{b}⁰) and the interfacial resistance (Rᵢₙₜ⁰). The symmetric cell was then subjected to a constant DC voltage (V, 20 mV), during which the initial current (I₀) was monitored until reaching the steady-state current (Iₛₛ). Another AC impedance test was then conducted to obtain the steady state bulk resistance (R_{b}^{ss}) and the steady state interfacial resistance (Rᵢₙₜ^{ss}). t_{Li+} was then calculated by the formula: t_{Li+}=IₛₛR_{b}^{ss}(V−I₀Rᵢₙₜ⁰)/(I₀R_{b}⁰(V−IₛₛRᵢₙₜ^{ss})).

In certain embodiments, lithium metal batteries were fabricated by assembling a LiFePO₄ cathode and a Li chip into a CR2032 coin cell. The cathode electrodes were prepared by homogenously blending LiFePO₄, acetylene black, and PVdF with a ratio of 7:2:1 in NMP. The resulting slurry was uniformly coated on a conductive carbon-coated Al foil and dried in a vacuum oven at 70° C. for 24 h. The cathodes and as-prepared LPC@UM electrolyte were pressed together at 200 Mpa to minimize interface resistance, and one drop (about 6 uL) of electrolyte was added to ensure permeation into the electrode matrix. For the control tests, a commercial PP separator (Celgard PP 3401) with 30 uL of LPC (comparable to the total amount of LPC in the cell with LPC@UM electrolyte) was selected as a reference. The specific capacity is calculated based on the active materials in the cathode, which corresponds to an areal loading of approximately 2 mg cm⁻². 1 C charge/discharge rate here is defined as 170 mA g⁻¹.

The cycling tests were carried out at 0.2, 0.5, 1, and 2 C for five cycles each and at 1 C for subsequent cycles at ambient temperature (electrochemical window: 2.4-4 V vs. Li/Li⁺). For LiFePO₄|Li₄Ti₅O₁₂ cell, Li₄Ti₅O₁₂ electrodes were prepared by the same procedure as that of LiFePO₄. The weight ratio between LiFePO₄ and Li₄Ti₅O₁₂ is one. The LPC@UM electrolyte was sandwiched between cathode and anode and pressed together under 200 MPa, and the resulting flow-free cells were initially cycled at 1 C and followed by a 5 C test (electrochemical window: 1-2.4 V). PP separators with equivalent amount of liquid electrolyte were used as reference.

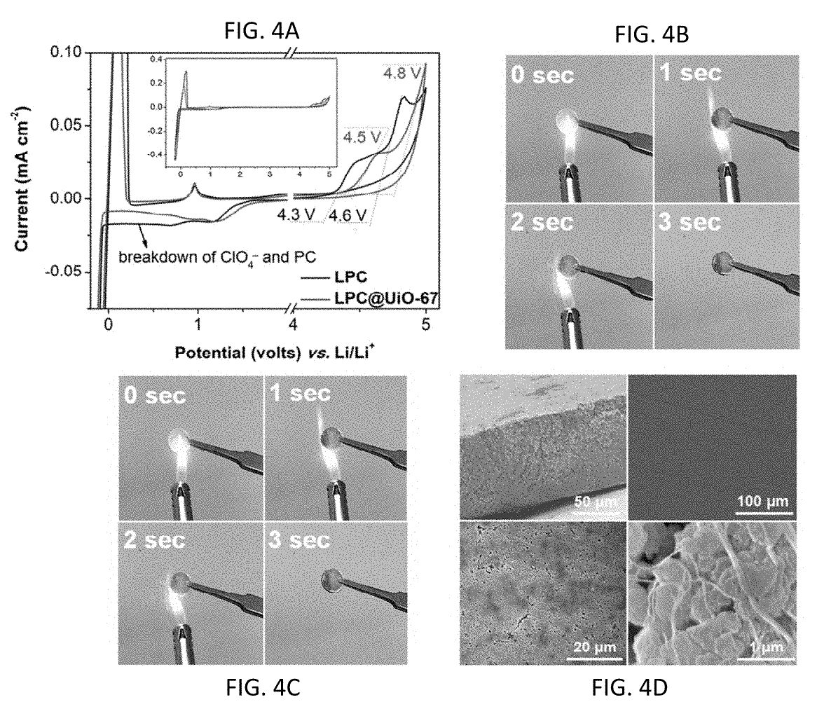

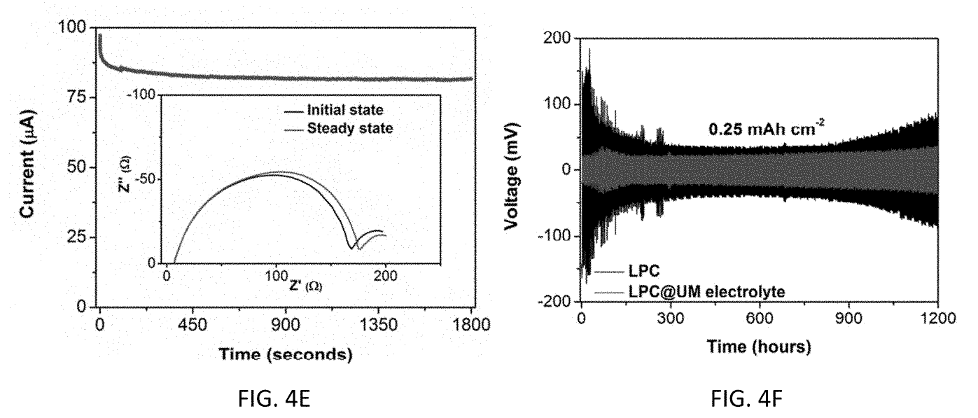

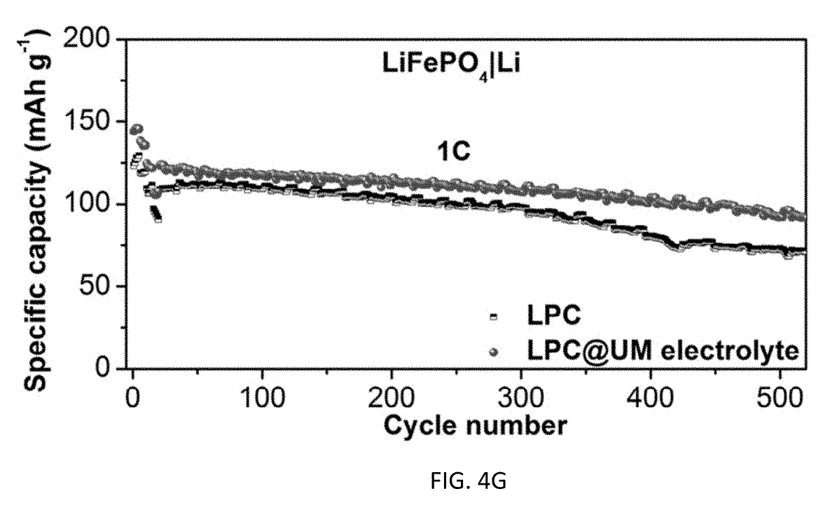

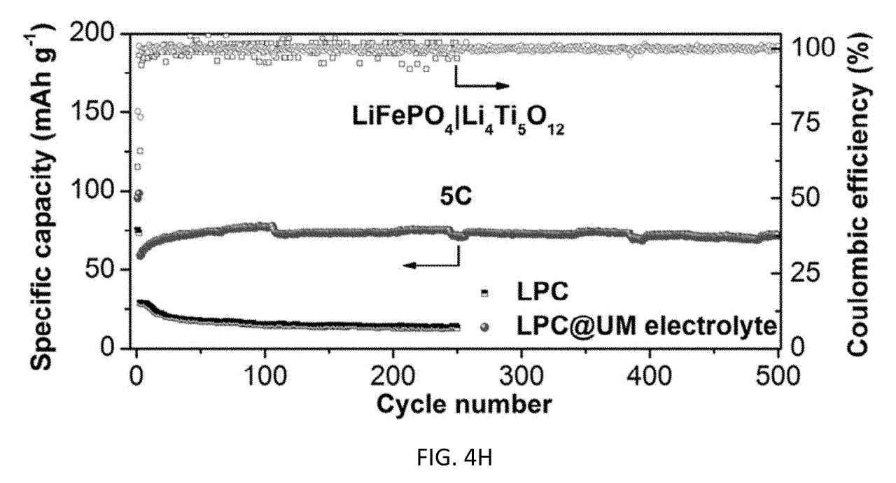

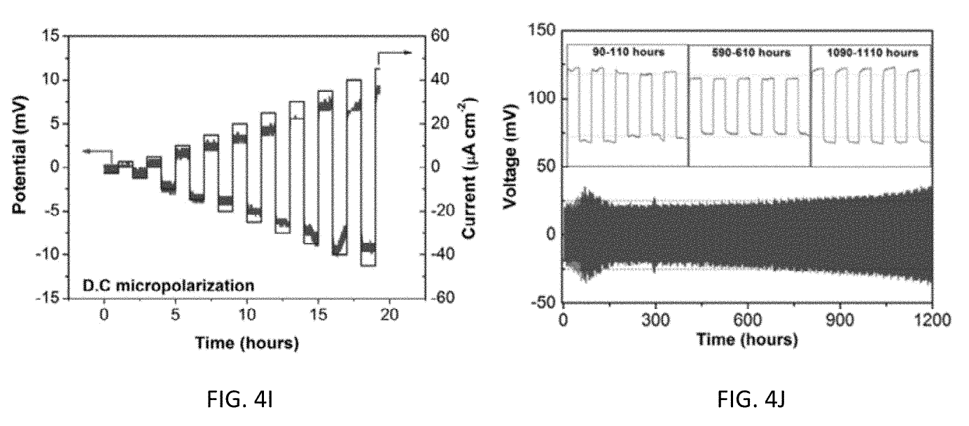

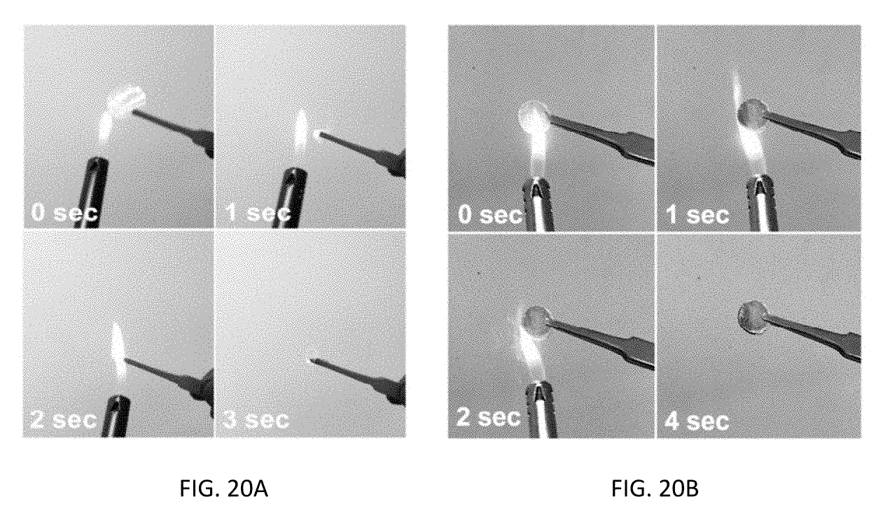

In certain embodiments, to demonstrate the use of MOF electrolytes for batteries, LPC@UiO-67 was chosen as an example. FIG. 4A shows the cyclic voltammetry (CV) of a cell, which contains a lithium metal counter electrode, an LPC@UiO-67 electrolyte pellet, and a stainless steel (SS) working electrode (Li|LPC@UiO-67|SS). The cell was tested using a scan rate of 0.5 mV s⁻¹ at a potential range from −0.2 to 5 V vs. Li/Li⁺. Liquid LPC and PP separator were used to assemble the reference cells. During the cathodic sweep below 1 V vs. Li/Li⁺, the current associated with the irreversible reduction of ClO₄⁻ and PC is less pronounced in LPC@UiO-67 in comparison with that of LPC [62]. During the anodic sweep, the onset of the oxidation current peak upshifts by 0.2 V for LPC@UiO-67 in comparison with that of LPC, demonstrating improved anodic stability of LPC@UiO-67. Compared with the CVs of LPC@HKUST-1 and LPC@UiO-66 (FIGS. 20A-20B), a working voltage window of LPC@UiO-67 from −0.2 to 4.5 V is confirmed.

Since the incorporated LPC component is firmly confined within the MOF scaffolds, substantially improved safety is achieved compared with that of conventional liquid electrolytes with high flammability. A combustion test of an LPC@UiO-67 electrolyte pellet and a LPC-saturated polypropylene (PP) membrane (Celgard 3401) is shown in FIGS. 4B and 20A-20B for comparison. Upon direct contact with a flame for 2 s, the LPC@UiO-67 electrolyte did not burn and only exhibits minor surface decomposition, in sharp contrast to the immediate combustion of the PP membrane soaked with liquid LPC. To integrate the electrolytes in batteries, flexible electrolyte membranes were fabricated with 10 wt. % of polytetrafluoroethylene (PTFE) as a binder. This membrane format is compatible with the electrochemical experiments and is the most likely form for it to be integrated into battery devices. The resulting LPC@UiO-67/PTFE electrolyte membrane is denoted as LPC@UM (FIG. 4C). As shown in FIG. 4D, cross-sectional and in-plane SEM images of the UiO-67/PTFE membrane explicitly show the formation of PTFE polymer fibers that tightly thread the MOF particles into a robust and dense structure with a thickness of about 70-100 μm.

Generally, Li⁺ cations are heavily solvated (approximately four solvent molecules per Li⁺ ion) [27] in conventional liquid carbonate electrolytes, resulting in relatively free anions and ion-pairings. This unavoidably leads to a low lithium-ion transfer number, t_{Li}⁺, which results in undesirable concentration polarization and low lithium plating efficiency. The t_{Li}⁺ of the LPC@UM electrolyte measured by the classical Bruce potentiostatic polarization method [63] (FIG. 4E) yields a high value of about 0.65. Although the value deviates from unity due to possible decomposition of PC on the surface of the membrane [64], such a t_{Li}⁺ number is much higher than the typical value of about 0.2-0.4 observed in liquid LPC electrolyte [65]. Therefore, these results provide convincing evidence that the biomimetic ionic channels in MOFs could largely immobilize ClO₄⁻ anions and enable dominant Li⁺ flux.

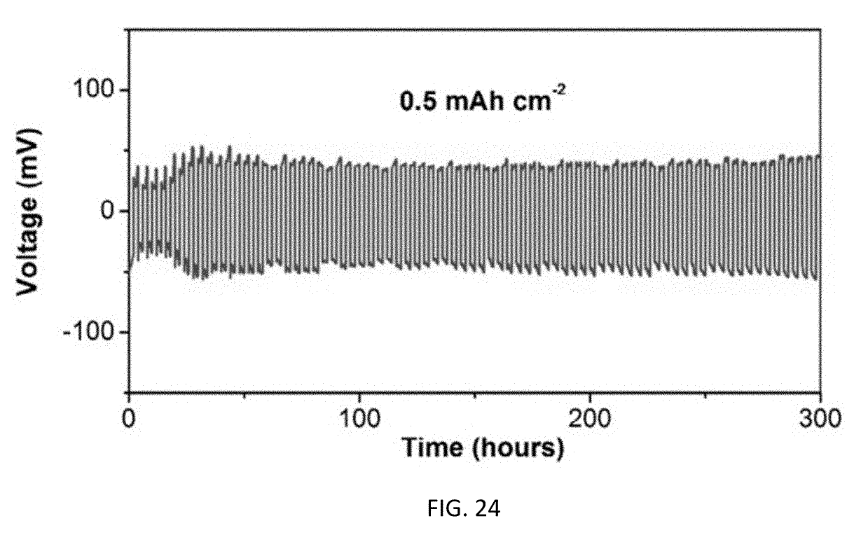

Another exemplary experiment involved using the LPC@UM as a membrane for the plating and stripping of lithium. These experiments were carried out in Li|LPC@UM|Li symmetric cells that were cycled at current densities up to 0.25 mA cm⁻². At low current density, we assume a linear relationship between potential and current according to Tafel equation at low value of polarization. FIG. 4I shows the DC (direct current) stepped current cycling from 2.5 to 50 uA cm⁻², the potential increased linearly with current, the corresponding resistance (about 175-200 Ω cm²) based on Ohm's law is in good agreement with ac impedance. Even at higher current density (0.125 and 0.25 mA cm⁻² in 2 hour segments) (FIGS. 4J and 24), the potentials at early stage are consistent with values predicted by dc micropolarization as well as ac impedance. The voltage profile of prolonged cycling of 0.125 mA cm⁻² is depicted at FIG. 4J the cell delivers a stable voltage plateau at about 20 mV up to 600 h operation despite it gradually accumulates minor overpotential of 10 mV by the end of the cycling (1200 h).

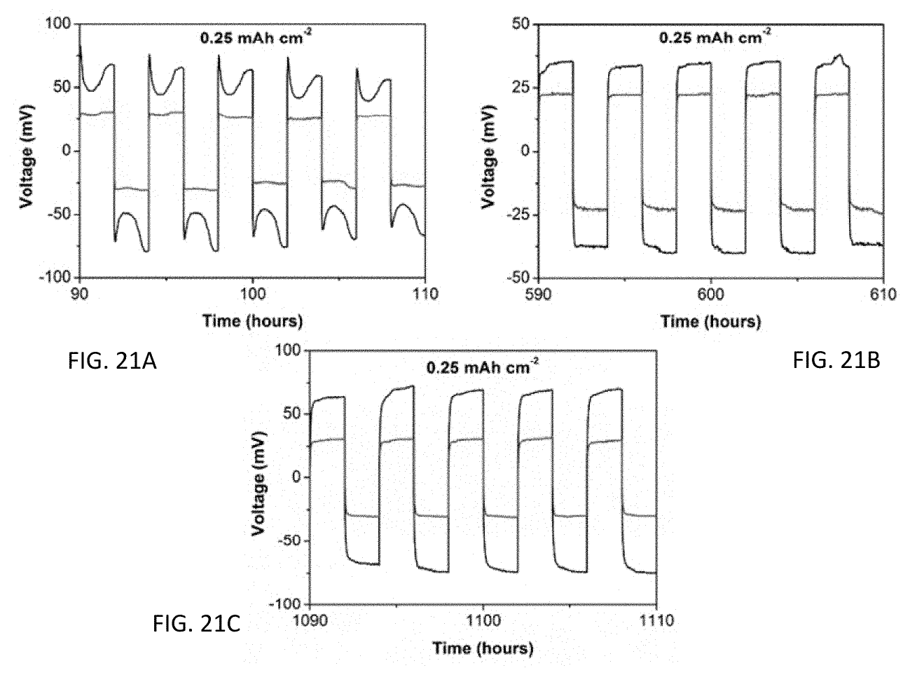

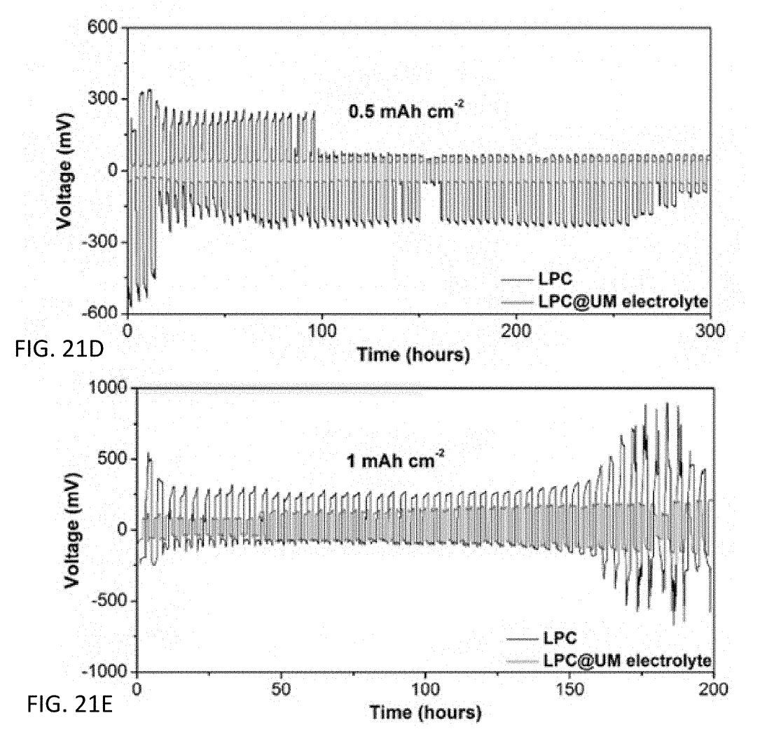

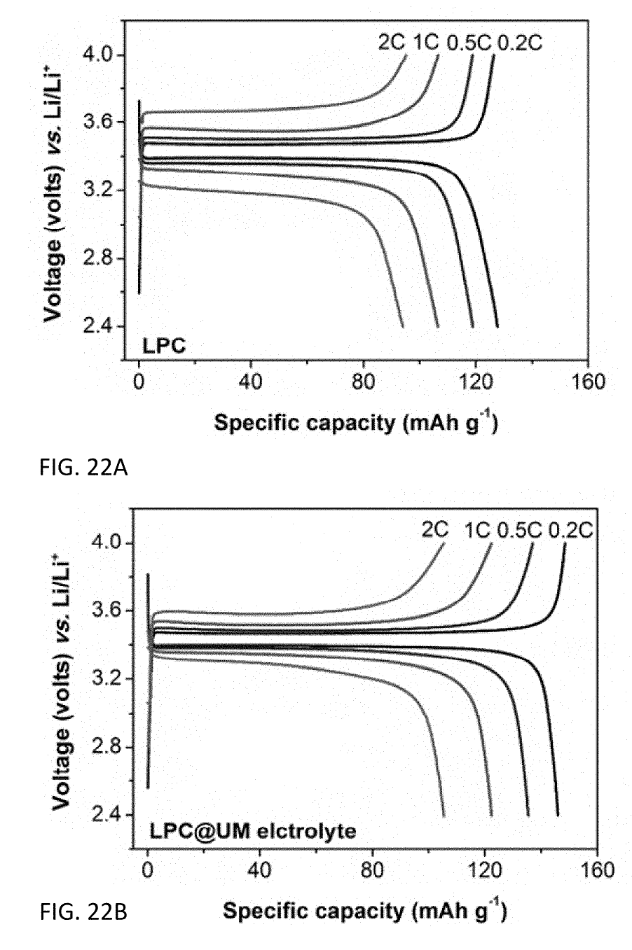

To investigate the compatibility between Li-metal anodes and LPC@UM, Li stripping and plating experiments were conducted using Li|LPC@UM|Li symmetric cells under 0.125 mA cm⁻² and 2 h per cycle. As shown in FIG. 4F, the cell with an LPC@UM electrolyte exhibits regular stepwise voltage curves during galvanostatic polarization up to 1200 h (well-maintained below 30 mV), suggesting exceptional stability. In comparison, the cell with a commercial separator and liquid LPC electrolyte shows higher overpotential fluctuating from 50 mV up to 180 mV and irregular curves (see zoom-in curves in FIGS. 21A-21C), which could be ascribed to high interfacial resistance and unstable SEI formation. More rigorous tests were carried out at 0.25 mA cm⁻² and 0.5 mA cm⁻² for 2 h in each cycle (FIGS. 21D-21E), where the LPC@UM electrolyte exhibits much smaller overpotentials for lithium stripping/plating.

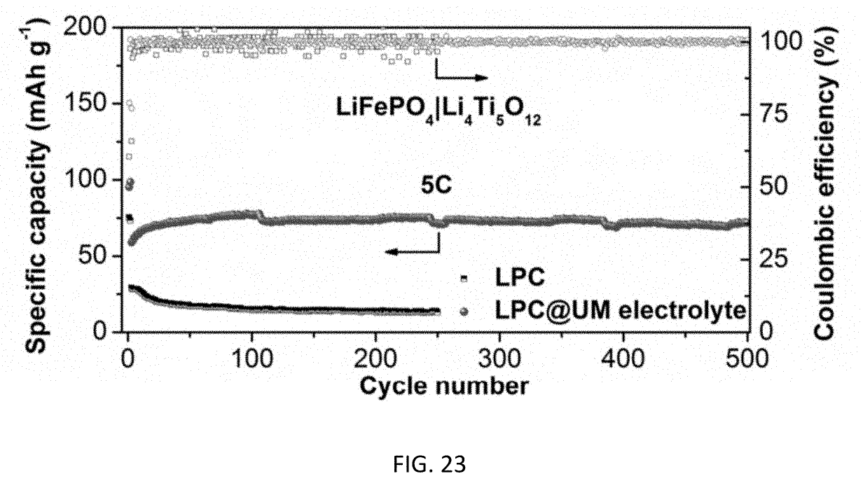

In certain embodiments, Li-metal batteries with LiFePO₄ cathodes and Li anodes (LiFePO₄|Li) were fabricated. As shown in FIG. 4G, LiFePO₄|Li batteries assembled with LPC@UM electrolyte or liquid electrolyte were initially evaluated at rates from 0.2 to 2 C and cycled at 1 C afterward. At 0.2 C, the cell with LPC@UM electrolyte exhibits a high specific capacity of 146 mAh g′, in contrast to only 123 mAh g⁻¹ obtained from the cell with LPC liquid electrolyte. A well-defined potential plateau up to 2 C can be observed (FIG. 23) with a capacity of 106 mAh g⁻¹, which is approximately 73% of the specific capacity at 0.2 C. By comparison, the cell based on liquid electrolyte could only afford 90 mAh eat 2 C. The substantial enhancement of power density could be attributed to the higher transference number of the LPC@UM electrolyte, which effectively eliminates the concentration gradient of the anions with reduced polarization. For consequent cycling at 1 C, the cell with LPC@UM electrolyte shows capacity retention of 75% at 500 cycles (0.05% fading per cycle). In contrast, the capacity retention for cells using liquid electrolyte is 65% at 500 cycles (0.07% fading per cycle). The improved cycling life indicates that LPC@UM electrolyte possesses super electrochemical stability and capability to reduce side reactions.

To further illustrate lithium-shuttling efficiency at higher current density, we assembled prototype Li-ion batteries using LiFePO₄ cathodes and Li₄Ti₅O₁₂ anodes, where an excess Li source is not available. The cells were cycled at a rate of 5 C, and no significant capacity loss is observed in the cell with LPC@UM electrolyte even after 500 cycles with an average Coulombic efficiency (CE) of 99.99% (FIG. 4H). As a reference, the cell based on liquid electrolyte shows drastic capacity decay, with only 25% capacity retention at 250 cycles and a low average CE of 99.67%. To the best of our knowledge, this is the first demonstration of successfully cycled Li-based battery cells using solid-state electrolytes based on MOFs.

In sum, the invention discloses, among other things, design and synthesis of MOFs-based electrolytes with biomimetic ionic channels for fast and effective transport of lithium ions are demonstrated. The approach results in six new superionic conductors, the best of which exhibits an ambient conductivity surpassing 10⁻³ S cm⁻¹, activation energies below 0.21 eV, electrochemical stability up to 4.5 V vs. Li/Li⁺, enhanced Li⁺ transference number, and low flammability. These features endow Li-based batteries with superior rate performance and cycling stability. These advantages over conventional LPC liquid electrolytes derive from their unique Li′ conduction mechanism, where the anions in LPC@MOFs electrolytes are immobilized to the OMS whereas the ClO₄⁻ anions in LPC are either free or pairing with Li⁺. These findings could open a new avenue of exploring MOFs as new solid-state electrolytes for next-generation battery devices.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### REFERENCES LIST

[1]. Armand M, Tarascon J M. Building better batteries. Nature 2008, 451(7179): 652-657.
[2]. Xu K. Electrolytes and interphases in Li-ion batteries and beyond. Chem Rev 2014, 114(23): 11503-11618.
[3]. Dias F B, Plomp L, Veldhuis J B J. Trends in polymer electrolytes for secondary lithium batteries. J Power Sources 2000, 88(2): 169-191.
[4]. Thangadurai V, Narayanan S, Pinzaru D. Garnet-type solid-state fast Li ion conductors for Li batteries: Critical review. Chem Soc Rev 2014, 43(13): 4714-4727.
[5]. Stramare S, Thangadurai V, Weppner W. Lithium lanthanum titanates: A review. Chem Mater 2003, 15(21): 3974-3990.
[6]. Quartarone E, Mustarelli P. Electrolytes for solid-state lithium rechargeable batteries: Recent advances and perspectives. Chem Soc Rev 2011, 40(5): 2525-2540.
[7]. Zheng G, Lee S W, Liang Z, Lee H-W, Yan K, Yao H, et al. Interconnected hollow carbon nanospheres for stable lithium metal anodes. Nat Nanotechnol 2014, 9(8): 618-623.
[8]. Lu Y, Tu Z, Archer L A. Stable lithium electrodeposition in liquid and nanoporous solid electrolytes. Nat Mater 2014, 13(10): 961-969.
[9]. Ding F, Xu W, Graff G L, Zhang J, Sushko M L, Chen X, et al. Dendrite-free lithium deposition via self-healing electrostatic shield mechanism. J Am Chem Soc 2013, 135(11): 4450-4456.
[10]. Xu W, Wang J, Ding F, Chen X, Nasybulin E, Zhang Y, et al. Lithium metal anodes for rechargeable batteries. Energy Environ Sci 2014, 7(2): 513-537.
[11]. Kamaya N, Homma K, Yamakawa Y, Hirayama M, Kanno R, Yonemura M, et al. A lithium superionic conductor. Nat Mater 2011, 10(9): 682-686.
[12]. Wenzel S, Randau S, LeichtweiB T, Weber D A, Sann J, Zeier W G, et al. Direct observation of the interfacial instability of the fast ionic conductor Li₁₀GeP₂Si₂ at the lithium metal anode. Chem Mater 2016, 28(7): 2400-2407.
[13]. Kato Y, Hori S, Saito T, Suzuki K, Hirayama M, Mitsui A, et al. High-power all-solid-state batteries using sulfide superionic conductors. Nat Energy 2016, 1: 16030.
[14]. Hartmann P, Leichtweiss T, Busche M R, Schneider M, Reich M, Sann J, et al. Degradation of NASICON-type materials in contact with lithium metal: Formation of mixed conducting interphases (MCI) on solid electrolytes. J Phys Chem C 2013, 117(41): 21064-21074.
[15]. Oh D Y, Nam Y J, Park K H, Jung S H, Cho S-J, Kim Y K, et al. Excellent compatibility of solvate ionic liquids with sulfide solid electrolytes: Toward favorable ionic contacts in bulk-type all-solid-state lithium-Ion batteries. Adv Energy Mater 2015, 5(22): 1500865.
[16]. Han X, Gong Y, Fu K, He X, Hitz G T, Dai J, et al. Negating interfacial impedance in garnet-based solid-state Li metal batteries. Nat Mater 2017, 16(5): 572-579.
[17]. Croce F, Appetecchi G B, Persi L, Scrosati B. Nanocomposite polymer electrolytes for lithium batteries. Nature 1998, 394(6692): 456-458.
[18]. Lemoine D, Jiang R, Taly A, Chataigneau T, Specht A, Grutter T. Ligand-gated ion channels: New insights into neurological disorders and ligand recognition. Chem Rev 2012, 112(12): 6285-6318.
[19]. Dawson R J P, Benz J, Stohler P, Tetaz T, Joseph C, Huber S, et al. Structure of the acid-sensing ion channel 1 in complex with the gating modifier Psalmotoxin 1. Nat Commun 2012, 3: 936.
[20]. Chui S S Y, Lo S M F, Charmant J P H, Orpen A G, Williams I D. Chemically functionalizable nanoporous material [Cu3(TMA)2(H2O)3]n. Science 1999, 283(5405): 1148.
[21]. Furukawa H, Cordova K E, O'Keeffe M, Yaghi O M. The Chemistry and Applications of Metal-Organic Frameworks. Science 2013, 341(6149).
[22]. Ramaswamy P, Wong N E, Shimizu G K H. MOFs as proton conductors—challenges and opportunities. Chem Soc Rev 2014, 43(16): 5913-5932.
[23]. Wiers B M, Foo M-L, Balsara N P, Long J R. A solid lithium electrolyte via addition of lithium isopropoxide to a metal-organic framework with open metal sites. J Am Chem Soc 2011, 133(37): 14522-14525.
[24]. Ameloot R, Aubrey M, Wiers B M, Gomora-Figueroa A P, Patel S N, Balsara N P, et al. Ionic conductivity in the metal-organic framework UiO-66 by dehydration and insertion of lithium tert-butoxide. Chem Eur J 2013, 19(18): 5533-5536.
[25]. Lee J-h, Im S-j, Park S-H, inventors; Electrolyte membrane for lithium battery, lithium battery using the electrolyte membrane, and method of preparing the electrolyte membrane. U.S. Pat. No. 9,105,940. 2015.
[26]. Talin A A, Centrone A, Ford A C, Foster M E, Stavila V, Haney P, et al. Tunable electrical conductivity in metal-organic framework thin-film devices. Science 2014, 343(6166): 66.
[27]. Skarmoutsos I, Ponnuchamy V, Vetere V, Mossa S. Li+ solvation in pure, binary, and ternary mixtures of organic carbonate electrolytes. J Phys Chem C 2015, 119(9): 4502-4515.
[28]. Dudney N J, West W C, Nanda J. Handbook of solid state batteries. World Scientific, 2016.
[29]. Xu H, Tao S, Jiang D. Proton conduction in crystalline and porous covalent organic frameworks. Nat Mater 2016, 15(7): 722-726.
[30]. Zhang J, Bai Y, Sun X-G, Li Y, Guo B, Chen J, et al. Superior Conductive Solid-like Electrolytes: Nanoconfining Liquids within the Hollow Structures. Nano Letters 2015, 15(5): 3398-3402.
[31]. Park J H, Suh K, Rohman M R, Hwang W, Yoon M, Kim K. Solid lithium electrolytes based on an organic molecular porous solid. Chem Commun 2015, 51(45): 9313-9316.
[32]. Fujie K, Ikeda R, Otsubo K, Yamada T, Kitagawa H. Lithium Ion Diffusion in a Metal-Organic Framework Mediated by an Ionic Liquid. Chem Mater 2015, 27(21): 7355-7361.
[33]. Llewellyn P L, Bourrelly S, Serre C, Vimont A, Daturi M, Hamon L, et al. High Uptakes of CO₂ and CH₄ in Mesoporous Metal-Organic Frameworks MIL-100 and MIL-101. Langmuir 2008, 24(14): 7245-7250.
[34]. Song J Y, Wang Y Y, Wan C C. Conductivity study of porous plasticized polymer electrolytes based on poly(vinylidene fluoride): A comparison with polypropylene separators. J Electrochem Soc 2000, 147(9): 3219-3225.
[35]. Volkringer C, Leclerc H, Lavalley J-C, Loiseau T, Ferey G, Daturi M, et al. Infrared Spectroscopy Investigation of the Acid Sites in the Metal-Organic Framework Aluminum Trimesate MIL-100(Al). J Phys Chem C 2012, 116(9): 5710-5719.
[36]. Chavan S, Vitillo J G, Gianolio D, Zavorotynska O, Civalleri B, Jakobsen S, et al. H2 storage in isostructural UiO-67 and UiO-66 MOFs. Phys Chem Chem Phys 2012, 14(5): 1614-1626.
[37]. Mizuno F, Hayashi A, Tadanaga K, Tatsumisago M. New, highly ion-conductive crystals precipitated from Li₂S—P255 glasses. Adv Mater 2005, 17(7): 918-921.
[38]. Murugan R, Thangadurai V, Weppner W. Fast lithium ion conduction in garnet-type Li₇La₃Zr₂O₁₂. Angewandte Chemie International Edition 2007, 46(41): 7778-7781.
[39]. Bloise A C, Donoso J P, Magon C J, Rosario A V, Pereira E C. NMR and conductivity study of PEO-based composite polymer electrolytes. Electrochim Acta 2003, 48(14-16): 2239-2246.
[40]. Bouchet R, Maria S, Meziane R, Aboulaich A, Lienafa L, Bonnet J-P, et al. Single-ion BAB triblock copolymers as highly efficient electrolytes for lithium-metal batteries. Nat Mater 2013, 12(5): 452-457.
[41]. Yu X, Bates J B, Jellison G E J, Hartb F X. A Stable Thin-Film Lithium Electrolyte: Lithium Phosphorus Oxynitride. J Electrochem Soc 1997, 144(2): 524-532.
[42]. Colomban P, Novak A. Proton transfer and superionic conductivity in solids and gels. Journal of Molecular Structure 1988, 177: 277-308.
[43]. Prestipino C, Regli L, Vitillo J G, Bonino F, Damin A, Lamberti C, et al. Local structure of framework Cu(II) in HKUST-1 metallorganic framework: Spectroscopic characterization upon activation and interaction with adsorbates. Chem Mater 2006, 18(5): 1337-1346.
[44]. Dhumal N R, Singh M P, Anderson J A, Kiefer J, Kim H J. Molecular interactions of a Cu-based metal-organic framework with a confined imidazolium-based ionic liquid: A combined density functional theory and experimental vibrational spectroscopy study. J Phys Chem C 2016, 120(6): 3295-3304.
[45]. Borfecchia E, Maurelli S, Gianolio D, Groppo E, Chiesa M, Bonino F, et al. Insights into Adsorption of NH3 on HKUST-1 Metal-Organic Framework: A Multitechnique Approach. J Phys Chem C 2012, 116(37): 19839-19850.
[46]. Sagane F, Abe T, Ogumi Z. Li+-ion transfer through the interface between Lition conductive ceramic electrolyte and Li+-ion-concentrated propylene carbonate solution. J Phys Chem C 2009, 113(46): 20135-20138.
[47]. Xuan X, Wang J, Tang J, Qu G, Lu J. Vibrational spectroscopic studies on ion solvation of lithium perchlorate in propylene carbonate+N,N-dimethylformamide mixtures. Spectrochim Acta Mol Biomol Spectrosc 2000, 56(11): 2131-2139.
[48]. Battisti D, Nazri G A, Klassen B, Aroca R. Vibrational studies of lithium perchlorate in propylene carbonate solutions. J Phys Chem A 1993, 97(22): 5826-5830.
[49]. Cazzanelli E, Croce F, Appetecchi G B, Benevelli F, Mustarelli P. Li⁺ solvation in ethylene carbonate-propylene carbonate concentrated solutions: A comprehensive model. J Chem Phys 1997, 107(15): 5740-5747.
[50]. Klassen B, Aroca R, Nazri M, Nazri G A. Raman spectra and transport properties of lithium perchlorate in ethylene carbonate based binary solvent systems for lithium batteries. J Phys Chem B 1998, 102(24): 4795-4801.
[51]. Klassen B, Aroca R, Nazri G A. Lithium perchlorate: Ab initio study of the structural and spectral changes associated with ion pairing. J Phys Chem A 1996, 100(22): 9334-9338.
[52]. Grondin J, Lassegues J-C, Chami M, Servant L, Talaga D, Henderson W A. Raman study of tetraglyme-LiClO₄ solvate structures. Phys Chem Chem Phys 2004, 6(17): 4260-4267.
[53]. Hathaway B J, Underhill A E. The infrared spectra of some transition-metal perchlorates. J Chem Soc 1961, 592: 3091-3096.
[54]. Lewis D L, Estes E D, Hodgson D J. The infrared spectra of coordinated perchlorates. J Cryst Mol Struct 1975, 5(1): 67-74.
[55]. Wickenden A E, Krause R A. Complexes of nickel(II) with acetonitrile. Coordination of perchlorate. Inorg Chem 1965, 4(3): 404-407.
[56]. Sant'Ana A C, Alves W A, Santos R H A, Ferreira A M D, Temperini M L A. The adsorption of 2,2′: 6′, 2″-terpyridine, 4′-(5-mercaptopentyl)-2,2′: 6′, 2″-terpyridinyl, and perchlorate on silver and copper surfaces monitored by SERS. Polyhedron 2003, 22(13): 1673-1682.
[57]. Pereira D C, Faria D LAd, Constantino V R L. Cu(II) hydroxy salts: Characterization of layered compounds by vibrational spectroscopy. J Braz Chem Soc 2006, 17: 1651-1657.
[58]. Wang Z, Huang B, Xue R, Chen L, Huang X. Ion association and salvation studies of LiClO₄/ethylene carbonate electrolyte by Raman and infrared spectroscopy. Journal of Electrochemistry Society 1998, 145(10): 3346-3350.
[59]. Brooksby P A, Fawcett W R. Infrared (attenuated total reflection) study of propylene carbonate solutions containing lithium and sodium perchlorate. Spectrochim Acta Mol Biomol Spectrosc 2006, 64(2): 372-382.
[60]. Tu Z, Zachman M J, Choudhury S, Wei S, Ma L, Yang Y, et al. Nanoporous Hybrid Electrolytes for High-Energy Batteries Based on Reactive Metal Anodes. Adv Energy Mater 2017, 7(8): 1602367-n/a.
[61]. Yamaguchi T, Hayakawa M, Matsuoka T, Koda S. Electric and Mechanical Relaxations of LiClO₄-Propylene Carbonate Systems in 100 MHz Region. J Phys Chem B 2009, 113(35): 11988-11998.
[62]. Aurbach D, Talyosef Y, Markovsky B, Markevich E, Zinigrad E, Asraf L, et al. Design of electrolyte solutions for Li and Li-ion batteries: a review. Electrochim Acta 2004, 50(2-3): 247-254.
[63]. Evans J, Vincent C A, Bruce P G. Electrochemical measurement of transference numbers in polymer electrolytes. Polymer 1987, 28(13): 2324-2328.
[64]. Lu Y, Tikekar M, Mohanty R, Hendrickson K, Ma L, Archer L A. Stable Cycling of Lithium Metal Batteries Using High Transference Number Electrolytes. Adv Energy Mater 2015, 5(9): 1402073-n/a.
[65]. Georén P, Lindbergh G. Characterisation and modelling of the transport properties in lithium battery gel electrolytes: Part I. The binary electrolyte P C/LiClO₄. Electrochim Acta 2004, 49(21): 3497-3505.
[66]. Seo Y-K, Hundal G, Jang I T, Hwang Y K, Jun C-H, Chang J-S. Microwave synthesis of hybrid inorganic-organic materials including porous Cu₃(BTC)₂ from Cu(II)-trimesate mixture. Microporous Mesoporous Mater, 119, 331-337 (2009).
[67]. Garcia Marquez A, et al. Green microwave synthesis of MIL-100(Al, Cr, Fe) nanoparticles for thin-film elaboration. Eur J Inorg Chem, 2012, 5165-5174 (2012).
[68]. Katz M J, et al. A facile synthesis of UiO-66, UiO-67 and their derivatives. Chem Commun, 49, 9449-9451 (2013).
[69]. Tranchemontagne D J, Hunt J R, Yaghi O M. Room temperature synthesis of metal-organic frameworks: MOF-5, MOF-74, MOF-177, MOF-199, and IRMOF-0. Tetrahedron, 64, 8553-8557 (2008).
[70]. Valenzano L, et al. Disclosing the complex structure of UiO-66 metal organic framework: A synergic combination of experiment and theory. Chem Mater, 23, 1700-1718 (2011).
[71]. Chavan S, et al. H2 storage in isostructural UiO-67 and UiO-66 MOFs. Phys Chem Chem Phys, 14, 1614-1626 (2012).
[72]. Dhumal N R, Singh M P, Anderson J A, Kiefer J, Kim H J. Molecular interactions of a Cu-based metal-organic framework with a confined imidazolium-based ionic liquid: A combined density functional theory and experimental vibrational spectroscopy study. J Phys Chem C, 120, 3295-3304 (2016).
[73]. Lewis D L, Estes E D, Hodgson D J. The infrared spectra of coordinated perchlorates. J Cryst Mol Struct, 5, 67-74 (1975).
[74]. Hathaway B J, Underhill A E. The infrared spectra of some transition-metal perchlorates. J Chem Soc, 592, 3091-3096 (1961).
[75]. Rowsell J L C, Spencer E C, Eckert J, Howard J A K, Yaghi O M. Gas adsorption sites in a large-pore metal-organic framework. Science, 309, 1350 (2005).
[76]. Li H, Eddaoudi M, O'Keeffe M, Yaghi O M. Design and synthesis of an exceptionally stable and highly porous metal-organic framework. Nature, 402, 276-279 (1999).
[77]. Perez E V, Balkus Jr K J, Ferraris J P, Musselman I H. Mixed-matrix membranes containing MOF-5 for gas separations. J Membr Sci, 328, 165-173 (2009).
[78]. Park J H, Suh K, Rohman M R, Hwang W, Yoon M, Kim K. Solid lithium electrolytes based on an organic molecular porous solid. Chem Commun, 51, 9313-9316 (2015).
[79]. Kim T-W, Chung P-W, Lin V S Y. Facile synthesis of monodisperse spherical MCM-48 mesoporous silica nanoparticles with controlled particle size. Chem Mater, 22, 5093-5104 (2010).

What is claimed is:

1. A solid-state electrolyte usable for ionic conductor for an electrochemical device, comprising:
a composite synthesized from a material of metal-organic frameworks (MOFs) soaked in a liquid electrolyte, the MOFs being a class of crystalline porous solids constructed from metal cluster nodes and organic linkers.

2. The solid-state electrolyte of claim 1, wherein the MOF material is pre-activated under vacuum at a temperature greater than 150° C. for a period of time.

3. The solid-state electrolyte of claim 2, wherein the MOF material comprises open metal sites (OMSs) that are corresponding to unsaturated metal centers created by activating pristine MOFs to remove guest molecules or partial ligands thereof.

4. The solid-state electrolyte of claim 1, wherein the MOF material comprises HKUST-1 having a formula of Cu₃(BTC)₂, MIL-100-Al having a formula of Al₃O(OH)(BTC)₂, MIL-100-Cr having a formula of Cr₃O(OH)(BTC)₂, MIL-100-Fe having a formula of Fe₃O(OH)(BTC)₂, UiO-66 having a formula of Zr₆O₄(OH)₄(BDC)₆, or UiO-67 having a formula of Zr₆O₄(OH)₄(BPDC)₆, wherein BTC is a benzene-1,3,5-tricarboxylic acid, BDC is a benzene-1,4-dicarboxylic acid, and BPDC is a biphenyl-4,4′-dicarboxylic acid.

5. The solid-state electrolyte of claim 1, wherein the liquid electrolyte comprises one or more non-aqueous solvents and metal salts dissolved in the one or more non-aqueous solvents,
wherein the one or more non-aqueous solvents are selected to match the surface properties of the MOF material; and
wherein the metal salts are selected to have anions with desired sizes, which depends, at least in part, upon the MOF material, wherein the anion sizes are selected to ensure that the salts to infiltrate into at least some of the pores of the MOFs, and become immobilized therein to form the ionic conducting channels.

6. The solid-state electrolyte of claim 5, wherein the non-aqueous liquid electrolyte solvents comprise ethylene carbonate (EC), propylene carbonate (PC), vinylene carbonate (VC), fluoroethylene carbonate (FEC), butylene carbonate (BC), dimethyl carbonate (DMC), diethyl carbonate (DEC), ethylmethyl carbonate (EMC), methylpropyl carbonate (MPC), butylmethyl carbonate (BMC), ethylpropyl carbonate (EPC), dipropyl carbonate (DPC), cyclopentanone, sulfolane, dimethyl sulfoxide, 3-methyl-1,3-oxazolidine-2-one, γ-butyrolactone, 1,2-di-ethoxymethane, tetrahydrofuran, 2-methyltetrahydrofuran, 1,3-dioxolane, methyl acetate, ethyl acetate, nitromethane, 1,3-propane sultone, γ-valerolactone, methyl isobutyryl acetate, 2-methoxyethyl acetate, 2-ethoxyethyl acetate, diethyl oxalate, an ionic liquid, chain ether compounds including at least one of gamma butyrolactone, gamma valerolactone, 1,2-dimethoxyethane and diethyl ether, cyclic ether compounds including at least one of tetrahydrofuran, 2-methyltetrahydrofuran, 1,3-dioxolane and dioxane, or a combination thereof.

7. The solid-state electrolyte of claim 6, wherein the metal salts comprise one or more of a lithium (Li) salt, a sodium (Na) salt, a magnesium (Mg) salt, and a zinc (Zn) salt,

8. The solid-state electrolyte of claim 7, wherein the liquid electrolyte comprises LiClO₄ and propylene carbonate (LPC).

9. A method for fabricating a solid-state electrolyte usable for ionic conductor for an electrochemical device, comprising:
providing a material of metal-organic frameworks (MOFs), the MOFs being a class of crystalline porous solids constructed from metal cluster nodes and organic linkers;
activating the MOF material under vacuum at a temperature greater than 150° C. for a period of time;
soaking the activated MOF material in a liquid electrolyte to form a mixture; and
filtrating the mixture and removing any excessive solvent to obtain the solid-state electrolyte in a free-flowing power form.

10. The method of claim 9, further comprising pressing the power into pellets.

11. The method of claim 9, wherein the period of time is more than 12 h.

12. The method of claim 9, wherein the activated MOF material comprises open metal sites (OMSs) that are corresponding to unsaturated metal centers created by activating pristine MOFs to remove guest molecules or partial ligands thereof.

13. The method of claim 9, wherein the MOF material comprises HKUST-1 having a formula of Cu₃(BTC)₂, MIL-100-Al having a formula of Al₃O(OH)(BTC)₂, MIL-100-Cr having a formula of Cr₃O(OH)(BTC)₂, MIL-100-Fe having a formula of Fe₃O(OH)(BTC)₂, UiO-66 having a formula of Zr₆O₄(OH)₄(BDC)₆, or UiO-67 having a formula of Zr₆O₄(OH)₄(BPDC)₆, wherein BTC is a benzene-1,3,5-tricarboxylic acid, BDC is a benzene-1,4-dicarboxylic acid, and BPDC is a biphenyl-4,4′-dicarboxylic acid.

14. The method of claim 9, wherein the liquid electrolyte comprises one or more non-aqueous solvents and metal salts dissolved in the one or more non-aqueous solvents,
wherein the one or more non-aqueous solvents are selected to match the surface properties of the MOF material; and
wherein the metal salts are selected to have anions with desired sizes, which depends, at least in part, upon the MOF material, wherein the anion sizes are selected to ensure that the salts to infiltrate into at least some of the pores of the MOFs, and become immobilized therein to form the ionic conducting channels.

15. The method of claim 14, wherein the liquid electrolyte comprises LiClO₄ and propylene carbonate (LPC).

16. A composite electrolyte membrane usable for ionic conductor for an electrochemical device, comprising:
the solid-state electrolyte of claim 1; and
a binder mixed with the solid-state electrolyte.

17. The composite electrolyte membrane of claim 16, wherein a concentration of the binder is in a range of 5-20 wt. % of the composite electrolyte membrane.

18. The composite electrolyte membrane of claim 16, wherein the binder comprises poly-propylene (PP), poly-ethylene (PE), glass fiber (GF), polyethylene oxide (PEO), polyvinylidene fluoride (PVDF), polytetrafluoroethylene (PTFE), polyallylamine (PAH), polyurethane, polyacrylonitrile (PAN), polymethylmethacrylate (PMMA), polytetraethylene glycol diacrylate, or copolymers thereof.

19. An electrochemical device, comprising:
the composite electrolyte membrane of claim 16;
a positive electrode; and
a negative electrode,
wherein the composite electrolyte membrane is disposed between the positive electrode and the negative electrode.

20. The electrochemical device of claim 19, being a lithium (Li) battery, a sodium (Na) battery, a magnesium (Mg) battery, or a zinc (Zn) battery,
wherein the positive electrode of the Li battery includes at least one of LiCoO₂ (LCO), LiNiMnCoO₂ (NMC), lithium iron phosphate (LiFePO₄), lithium ironfluorophosphate (Li₂FePO₄F), an over-lithiated layer by layer cathode, spinel lithium manganese oxide (LiMn₂O₄), lithium cobalt oxide (LiCoO₂), LiNi_{0.5}Mn_{1.5}O₄, lithium nickel cobalt aluminum oxide, lithium vanadium oxide (LiV₂O₅), Li₂MSiO₄ wherein M is composed of any ratio of Co, Fe, and/or Mn, and a material that undergoes lithium insertion and deinsertion;
wherein the positive electrode of the Na battery includes at least one of NaMnO₂, NaFePO₄, and Na₃V₂(PO₄)₃;
wherein the positive electrode of the Mg battery includes at least one of TiSe₂, MgFePO₄F, MgCo₂O₄, and V₂O₅;
wherein the positive electrode of the Zn battery includes at least one of γ-MnO₂, ZnMn₂O₄, and ZnMnO₂;
wherein the negative electrode of the Li battery includes at least one of Li metal, graphite, hard or soft carbon, graphene, carbon nanotubes, titanium oxide, silicon (Si), tin (Sn), germanium (Ge), silicon monoxide (SiO), silicon oxide (SiO₂), tin oxide (SnO₂), transition metal oxide, and a material that undergoes intercalation, conversion or alloying reactions with lithium; and
wherein the negative electrodes of the Na, Mg and Zn batteries include Na metal, Mg metal, and Zn metal, respectively.
